(19) United States
(12) Patent Application Publication
(10) Pub. No.: US 2016/0301637 A1
(43) Pub. Date: Oct. 13, 2016

(54) RECIPIENT-CENTRIC, LIST-BASED, ARTIFICIAL INTELLIGENCE-BASED SMART MESSAGING

(71) Applicant: RECFIVE LLC, New York, NY (US)

(72) Inventor: Ari Horowitz, New York, NY (US)

(21) Appl. No.: 15/097,247

(22) Filed: Apr. 12, 2016

Related U.S. Application Data
(60) Provisional application No. 62/146,349, filed on Apr. 12, 2015.

(51) Int. Cl. H04L 12/58; G06F 3/0484; G06F 3/0482

(52) U.S. Cl. CPC H04L 51/046; G06F 3/0482; G06F 3/04842; H04L 51/20

(57) ABSTRACT

Systems and methods are disclosed for recipient-centric, list-based messaging. In one implementation, a processing device receives, from a first device associated with a first user, a selection of one or more contacts, receives one or more request parameters from the first device, identifies, based on the selection of the one or more contacts and the one or more request parameters, one or more content items that are (a) associated with at least one of the one or more contacts and (b) associated with at least one of the one or more request parameters, and provides a first list of the one or more content items to the first device and to one or more devices that correspond to the one or more contacts.

### CROSS-REFERENCE TO RELATED APPLICATION

This application is related to and claims the benefit of U.S. Patent Application No. 62/146,349, filed Apr. 12, 2015 which is incorporated herein by reference in its entirety.

### TECHNICAL FIELD

Aspects and implementations of the present disclosure relate to messaging, and more specifically, to recipient-centric, list-based messaging.

### BACKGROUND

Messaging applications can enable users to compose and transmit messages (e.g., text-based messages) to one another. Examples of such messaging applications include WhatsApp, iMessage, Facebook Messenger, etc.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a processing device receives, from a first device associated with a first user, a selection of one or more contacts, receives one or more request parameters from the first device, identifies, based on the selection of the one or more contacts and the one or more request parameters, one or more content items that are (a) associated with at least one of the one or more contacts and (b) associated with at least one of the one or more request parameters, and provides a first list of the one or more content items to the first device and to one or more devices that correspond to the one or more contacts.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an exemplary system architecture, in accordance with one implementation of the present disclosure.

FIG. 2 depicts an exemplary implementation of a device, in accordance with one implementation of the present disclosure.

FIG. 3 depicts a flow diagram of aspects of recipient-centric messaging in accordance with one implementation of the present disclosure.

FIGS. 4A-4C depict respective graphical representations of various exemplary user interfaces in accordance implementations of the present disclosure.

FIG. 5 depicts a graphical representation of an exemplary user interface in accordance with one implementation of the present disclosure.

FIGS. 6A-6D depict respective graphical representations of various exemplary user interfaces in accordance with implementations of the present disclosure.

FIG. 7 depicts a graphical representation of an exemplary user interface in accordance with one implementation of the present disclosure.

FIG. 8 depicts a graphical representation of an exemplary user interface in accordance with one implementation of the present disclosure.

FIGS. 9A-9D depict respective graphical representations of various exemplary user interfaces in accordance with implementations of the present disclosure.

FIG. 10 depicts a graphical representation of an exemplary user interface in accordance with one implementation of the present disclosure.

FIG. 11 depicts a graphical representation of an exemplary user interface in accordance with one implementation of the present disclosure.

FIGS. 12A-12B depict respective graphical representations of various exemplary user interfaces in accordance with implementations of the present disclosure.

FIG. 13 depicts a graphical representation of an exemplary user interface in accordance with one implementation of the present disclosure.

FIG. 14 depicts an illustrative computer system in accordance with one implementation of the present disclosure.

### DETAILED DESCRIPTION

Aspects and implementations of the present disclosure are directed to contact-centric messaging.

It can be appreciated that existing content discovery applications/services often initiate such discovery in response to a user's entry of search parameters (in response to which a list of search results is generated and may be subsequently filtered). While such services may subsequently account for social networking data/connections in relation to the referenced search results (e.g., in order to identify contacts within a user's social graph that may have reviewed or been to one of the places listed in the search results), in certain scenarios (e.g., when seeking a particular type of restaurant/experience in a new city) a user may value/prioritize the source of the recommendation over (or at least as much as) a specific search criteria/category.

Moreover, in scenarios in which a user wishes to request feedback/input from others (e.g., friends, contacts, individuals recognized as authorities or experts on a particular topic), such a requesting user may not be aware that such users/contacts/experts may have already provided related feedback/input (e.g., to another user who previously presented a similar request). Additionally, in scenarios in which numerous potential options are available to a user (e.g., when searching for a restaurant in a large city), it can be difficult for users prompted for feedback to provide such feedback in a manner that is collectively coherent/focused (and thus useful to the user that requested the feedback).

Accordingly, described herein are technologies that enable a user to compose a message (or initiate a content/feedback request) in a recipient-centric manner. In doing so, the requestor can initially be directed to select specific users to which their request is to be directed. Based on the preferences of those selected users (as well as other factors, e.g., the location of the requestor), the described technologies can dynamically generate and provide an intelligent, curated list of suggestions. As such, the described technologies initially generate a curated list based on the preferences, histories, prior recommendations, etc., associated with the requesting user and/or recipients to which the request is to be directed. As the requesting user adds or removes recipients of the list-based message, the described technologies can revise/refine the generated list (e.g., based on the preferences of the selected users).

Accordingly, it can be appreciated that the described technologies are directed to and address specific technical challenges and longstanding deficiencies in multiple technical areas, including but not limited to search, content discovery, information retrieval, and messaging. For example, existing technologies do not enable content generated during messaging sessions to be stored and retrieved as structured data in a manner that enables such data to be leveraged or linked in subsequent interactions/instances. Additionally, existing technologies do not enable users seeking input/feedback to effectively request and receive input from other users with respect to which they have a direct/personal connection with and/or otherwise trust or value. As described in detail herein, the disclosed technologies provide specific, technical solutions to the referenced technical challenges and unmet needs in the referenced technical fields.

At this juncture it should also be noted that various implementations of the disclosed technologies provide numerous advantages and improvements upon existing approaches. As noted, while existing messaging services often initiate the message composition process with a blank page/message, the described technologies utilize a dynamic list-based messaging format across one or multiple recipients. As described herein, the messages utilized in the described technologies incorporate dynamically updated, prioritized lists which can be updated on an ongoing basis based on received feedback. Such dynamic lists can be presented to the requesting user in a manner that enables him/her to quickly assess the collective feedback received from multiple users with respect to the request and the various items included in the list. Additionally, the feedback received can be stored and subsequently leveraged, e.g., in response to subsequent requests that are determined to be related, either as a requestor or as a recipient of a similar request

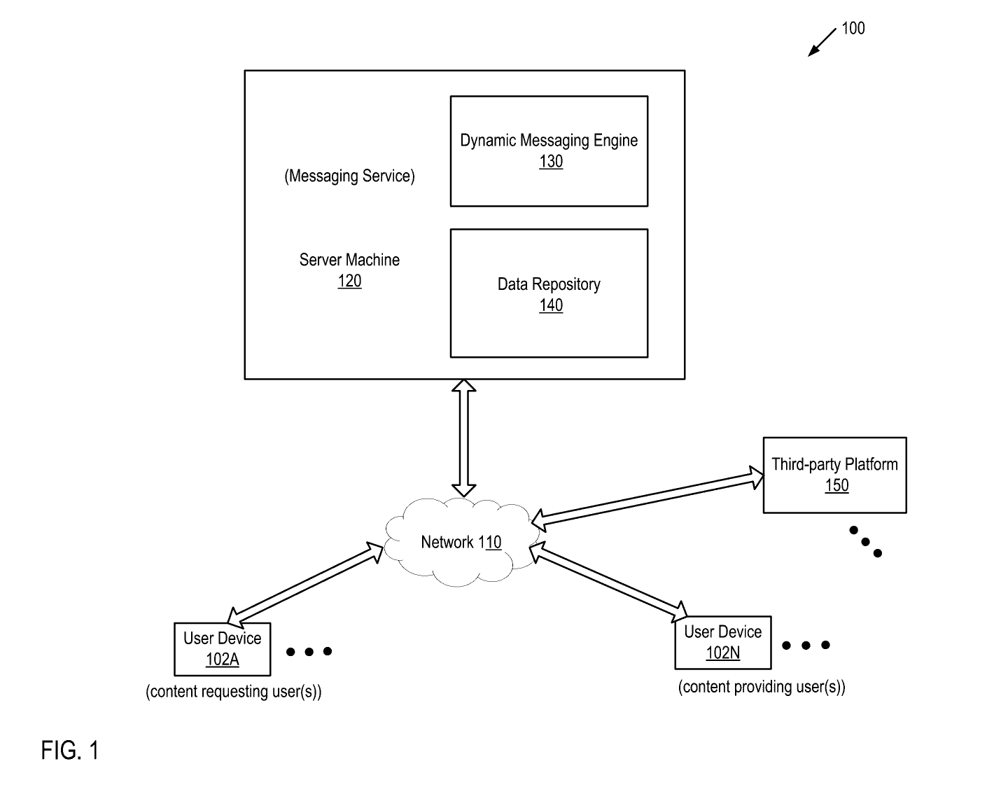

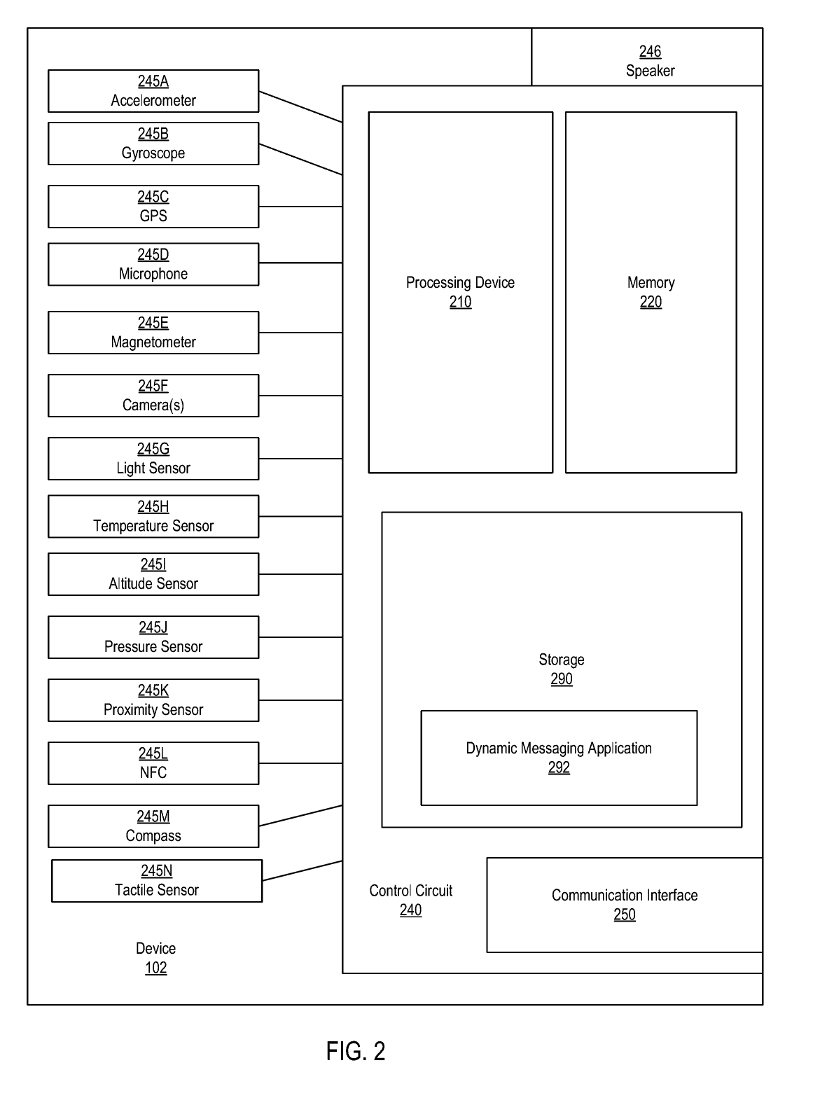

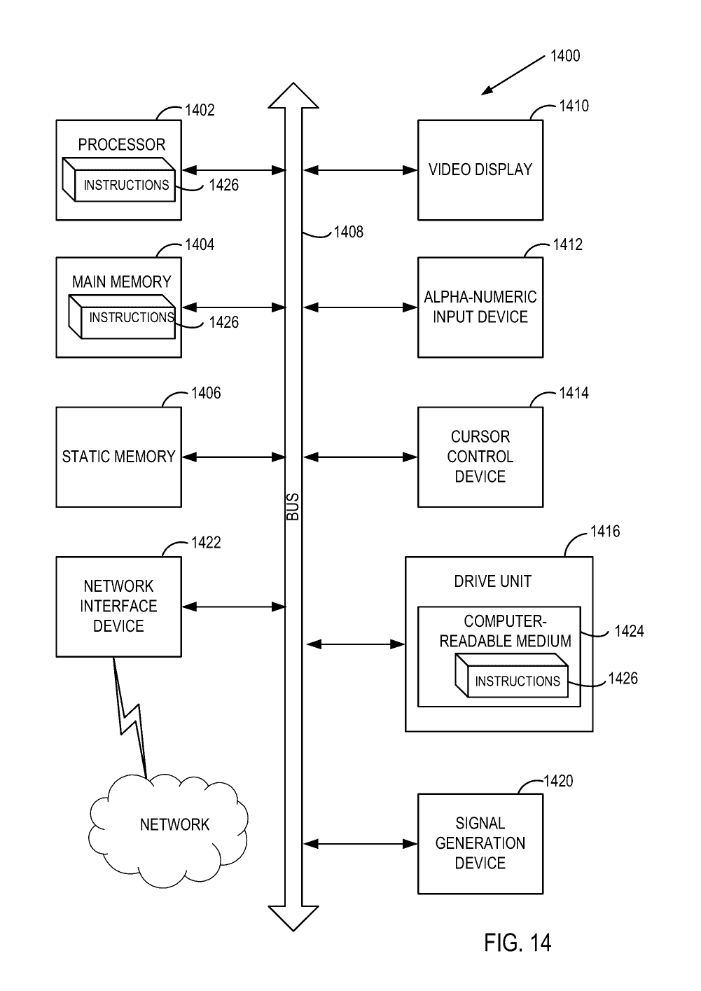

FIG. 1 depicts an illustrative system architecture 100, in accordance with one implementation of the present disclosure. The system architecture 100 includes user devices 102A-N, server machine 120, and third-party platform 150. These various elements or components can be connected to one another via network 110, which can be a public network (e.g., the Internet), a private network (e.g., a local area network (LAN) or wide area network (WAN)), or a combination thereof. Additionally, in certain implementations various elements may communicate and/or otherwise interface directly with one another. Further aspects of one or more of the various devices depicted in FIG. 1 are described below with respect to FIGS. 2 and 14.

Each user device 102 can be a rackmount server, a router computer, a personal computer, a portable digital assistant, a mobile phone, a laptop computer, a tablet computer, a camera, a video camera, a netbook, a desktop computer, a media center, a smartphone, a watch, a smartwatch, an in-vehicle computer/system, any combination of the above, or any other such computing device capable of implementing the various features described herein. Various applications, such as mobile applications (‘apps’), web browsers, etc. (not shown) may run on the user device (e.g., on the OS of the user device). It should be understood that, in certain implementations, each user device 102 can also include and/or incorporate various sensors and/or communications interfaces (including but not limited to those depicted in FIG. 2 with respect to device 102 and/or described herein). Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, WiFi interface, USB interface, NFC interface, etc. It should also be understood that, as described herein, certain user devices (e.g., user device 102A) may take on the role of content requestors while other user devices (e.g., user device 102N) may take on the role of content receivers/providers, and that any single device may assume either role (e.g., with respect to different messages/requests).

As noted, in certain implementations, user device(s) 102 (e.g., devices corresponding to content requesting users and content providing users) can also include and/or incorporate various sensors and/or communications interfaces. By way of illustration, FIG. 2 depicts one exemplary implementation of user device 102. As shown in FIG. 2, device 102 can include a control circuit 240 (e.g., a motherboard) which is operatively connected to various hardware and/or software components that serve to enable various operations, such as those described herein. Control circuit 240 can be operatively connected to processing device 210 and memory 220. Processing device 210 serves to execute instructions for software that can be loaded into memory 220. Processing device 210 can be a number of processors, a multi-processor core, or some other type of processor, depending on the particular implementation. Further, processing device 210 can be implemented using a number of heterogeneous processor systems in which a main processor is present with secondary processors on a single chip. As another illustrative example, processing device 210 can be a symmetric multi-processor system containing multiple processors of the same type.

Memory 220 and/or storage 290 may be accessible by processing device 210, thereby enabling processing device 210 to receive and execute instructions stored on memory 220 and/or on storage 290. Memory 220 can be, for example, a random access memory (RAM) or any other suitable volatile or non-volatile computer readable storage medium. In addition, memory 220 can be fixed or removable. Storage 290 can take various forms, depending on the particular implementation. For example, storage 290 can contain one or more components or devices. For example, storage 290 can be a hard drive, a flash memory, a rewritable optical disk, a rewritable magnetic tape, or some combination of the above. Storage 290 also can be fixed or removable.

As shown in FIG. 2, storage 290 can store dynamic messaging application 292. In certain implementations, dynamic messaging application 292 can be, for example, instructions, an ‘app,’ etc., that can be loaded into memory 220 and/or executed by processing device 210, in order to enable a user of the device to interact with and/or otherwise utilize the dynamic messaging technologies described herein (e.g., in conjunction with/communication with server 120).

A communication interface 250 is also operatively connected to control circuit 240. Communication interface 250 can be any interface (or multiple interfaces) that enables communication between user device 104 and one or more external devices, machines, platforms, systems, and/or elements (including but not limited to those depicted in FIG. 1 and described herein). Communication interface 250 can include (but is not limited to) a modem, a Network Interface Card (NIC), an integrated network interface, a radio frequency transmitter/receiver (e.g., WiFi, Bluetooth, cellular, NFC), a satellite communication transmitter/receiver, an infrared port, a USB connection, or any other such interfaces for connecting device 102 to other computing devices, systems, platforms, and/or communication networks such as the Internet. Such connections can include a wired connection or a wireless connection (e.g. 802.11) though it should be understood that communication interface 250 can be practically any interface that enables communication to/from the control circuit 240 and/or the various components described herein.

At various points during the operation of described technologies, device 102 can communicate with one or more other devices, systems, platforms, servers, etc., such as those depicted in FIG. 1 and/or described herein. Such devices, systems, platforms, servers, etc., can transmit and/or receive data to/from the user device 102, thereby enhancing the operation of the described technologies, such as is described in detail herein. It should be understood that the referenced devices, systems, platforms, servers, etc., can be in direct communication with user device 102, indirect communication with user device 102, constant/ongoing communication with user device 102, periodic communication with user device 102, and/or can be communicatively coordinated with user device 102, as described herein.

Also connected to and/or in communication with control circuit 240 of user device 104 are one or more sensors 245A-245N (collectively, sensors 245). Sensors 245 can be various components, devices, and/or receivers that can be incorporated/integrated within and/or in communication with user device 102. Sensors 245 can be configured to detect one or more stimuli, phenomena, or any other such inputs, described herein. Examples of such sensors 245 include, but are not limited to, an accelerometer 245A, a gyroscope 245B, a GPS receiver 245C, a microphone 245D, a magnetometer 245E, a camera 245F, a light sensor 245G, a temperature sensor 245H, an altitude sensor 245I, a pressure sensor 245J, a proximity sensor 245K, a near-field communication (NFC) device 245L, a compass 245M, and a tactile sensor 245N. As described herein, device 102 can perceive/receive various inputs from sensors 245 and such inputs can be used to initiate, enable, and/or enhance various operations and/or aspects thereof, such as is described herein. By way of example, inputs received via GPS receiver 245C can be processed to determine a location of device 102. The determination of such a location (based on inputs originating from GPS receiver 245C) can be utilized in conjunction with various messaging-related functionality (e.g., to route a message to a user that is or can be determined to have been present in a particular location), as well as determinations as to whether various other devices are located in the same location as (e.g., within the same city, country, etc.) and/or within a defined proximity of the referenced device, as described herein.

At this juncture it should be noted that while the foregoing description (e.g., with respect to sensors 245) has been directed to user device 102, various other devices, systems, servers, platforms, etc. (such as are depicted in FIG. 1 and/or described herein) can similarly incorporate the components, elements, and/or capabilities described with respect to user device 102. For example, practically any of the various devices 102A-N may also incorporate one or more of the referenced components, elements, and/or capabilities. It should also be understood that certain aspects and implementations of various devices, systems, servers, platforms, etc., such as those depicted in FIG. 1 and/or described herein, are also described in greater detail below in relation to FIG. 14.

Server machine 120 can be a rackmount server, a router computer, a personal computer, a portable digital assistant, a mobile phone, a laptop computer, a tablet computer, a camera, a video camera, a netbook, a desktop computer, a smartphone, any combination of the above, or any other such computing device capable of implementing the various features described herein. Server machine 120 can include components such as dynamic messaging engine 130, and data repository 140. The components can be combined together or separated in further components, according to a particular implementation. It should be noted that in some implementations, various components of server machine 120 may run on separate machines (for example, data repository 140 can be a separate device). Moreover, some operations of certain of the components are described in more detail below. Additionally, in certain implementations, server machine 120 can also include and/or incorporate various sensors and/or communications interfaces (including but not limited to those depicted in FIG. 2 and described in relation to user device 102).

Data repository 140 can be hosted by one or more storage devices, such as main memory, magnetic or optical storage based disks, tapes or hard drives, NAS, SAN, and so forth. In some implementations, data repository 140 can be a network-attached file server, while in other implementations data repository 140 can be some other type of persistent storage such as an object-oriented database, a relational database, and so forth, that may be hosted by the server machine 120 or one or more different machines coupled to the server machine 120 via the network 110, while in yet other implementations data repository 140 may be a database that is hosted by another entity and made accessible to server machine 120. Data repository 140 can store and maintain records which include and/or otherwise reflect various preferences, activity histories of different users (e.g., their favorite establishments, those that they frequent often, feedback that they have provided in the past, etc.), and/or messaging content generated/provided by such users (reflecting, for example, inputs, feedback, and/or other content that a user has provided, e.g., in previous messages, such as regarding a particular establishment, in response to a particular question, etc.).

It should be understood that though FIG. 1 depicts server machine 120 and devices 102 as being discrete components, in various implementations any number of such components (and/or elements/functions thereof) can be combined, such as within a single component/system. For example, in certain implementations user device 102 can incorporate features of server machine 120.

Third-party platform(s) 150 can be one or more servers, computers, devices, etc., that provide a framework for social networking service (e.g., Facebook, Twitter, etc.) and/or a messaging service (e.g., SMS, WhatsApp, iMessage, etc.). Such platforms/services can enable users to communicate, share information with one another, and/or disseminate information (e.g., publicly, privately, and/or to a defined group of users). In certain implementations, such platform(s) can receive and transmit content and/or messages between users (e.g., via a server or servers) and provide an application that enables users to generate, transmit, receive and/or view such content/messages.

As described in detail herein, various technologies are disclosed that enable recipient-centric messaging. In certain implementations, such technologies can encompass operations performed by and/or in conjunction with server machine 120 and/or dynamic messaging engine 130.

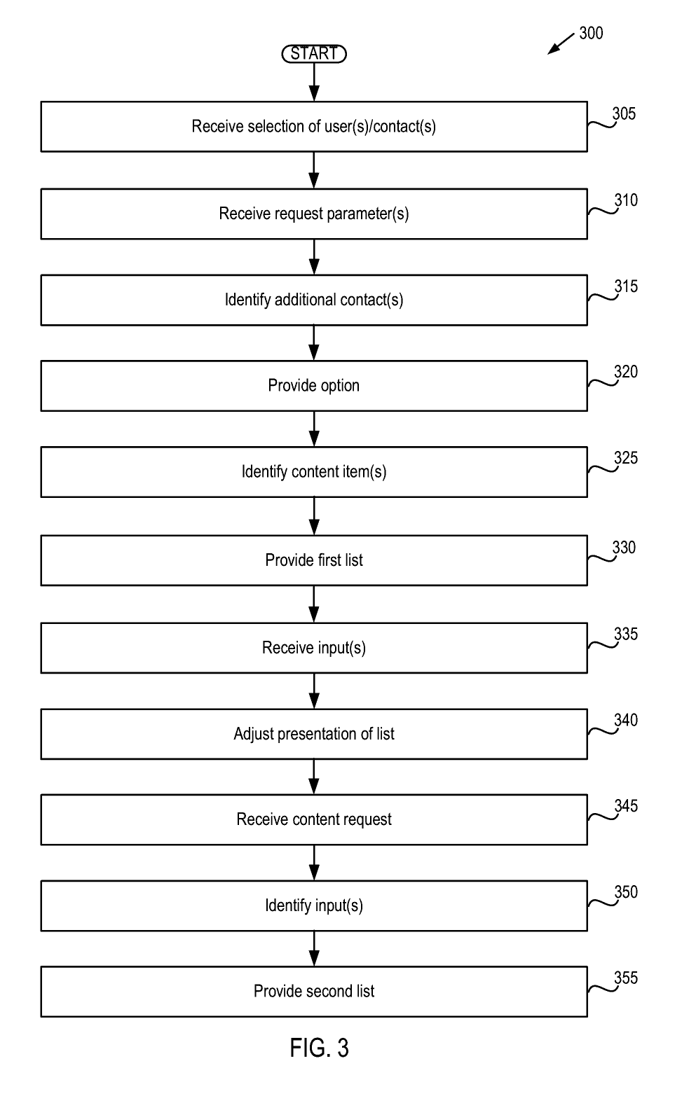

FIG. 3 depicts a flow diagram of aspects of a method 300 for recipient-centric messaging. The method is performed by processing logic that may comprise hardware (circuitry, dedicated logic, etc.), software (such as is run on a computing device, such as those described herein), or a combination of both. In one implementation, the method is performed by one or more elements depicted and/or described in relation to FIG. 1 (including but not limited to dynamic messaging engine 130, server 120, and/or user device(s) 102A-N) and/or FIG. 2 (e.g., dynamic messaging application 292 and/or device 102), while in some other implementations, one or more blocks of FIG. 3 may be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

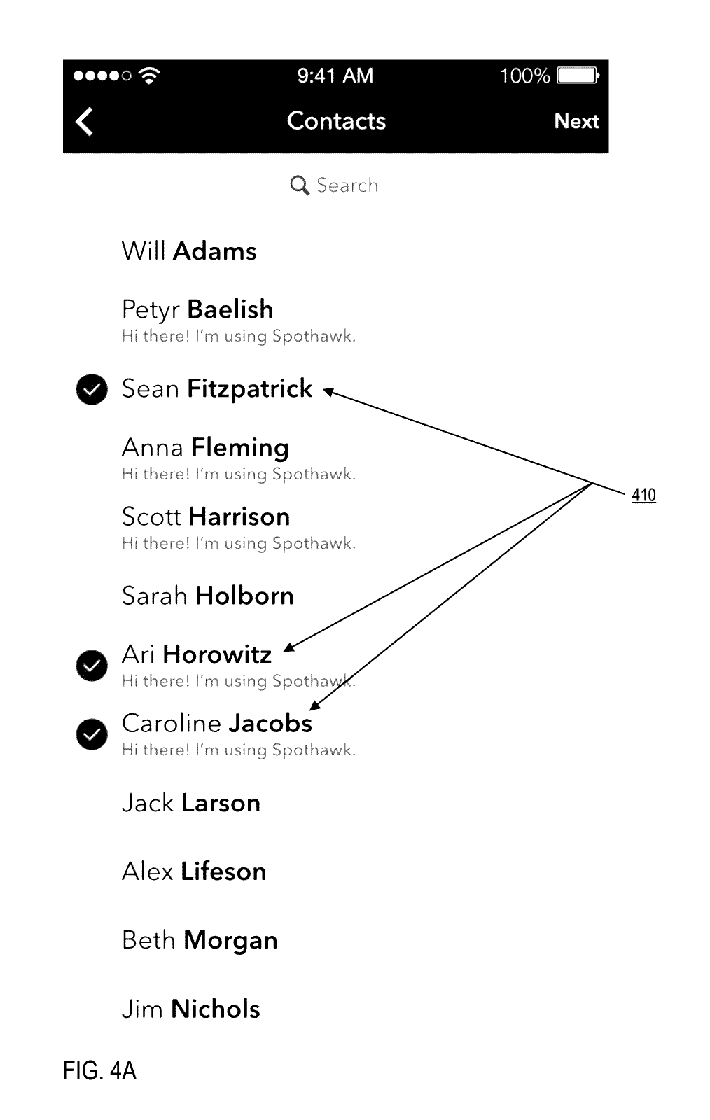

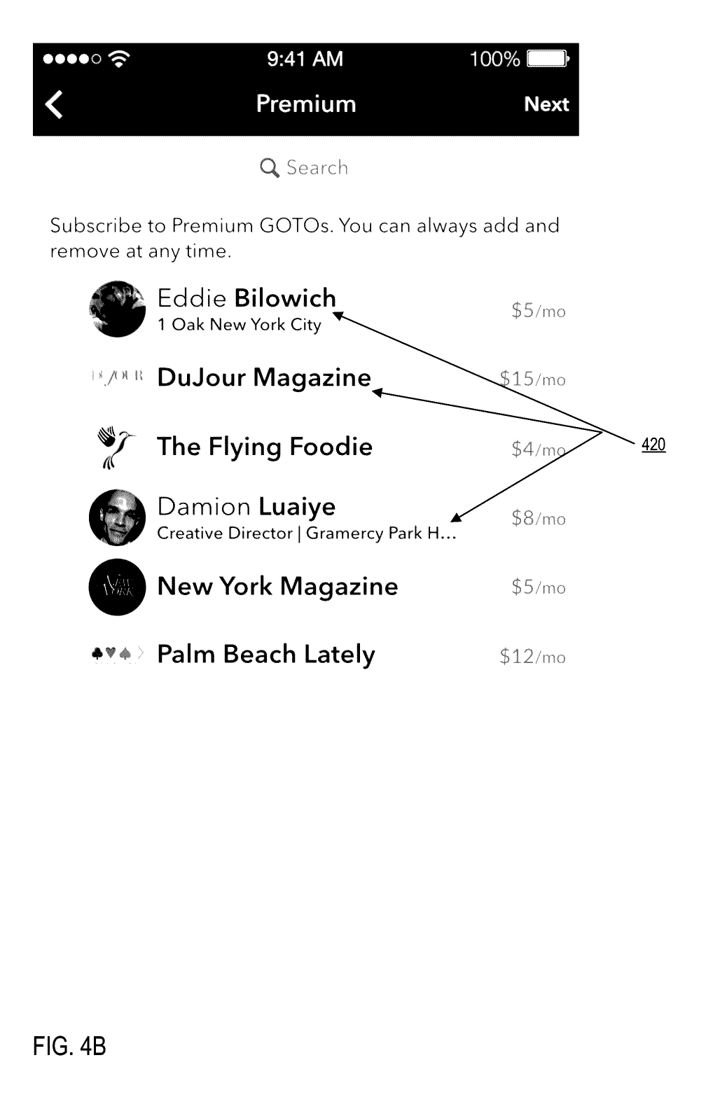

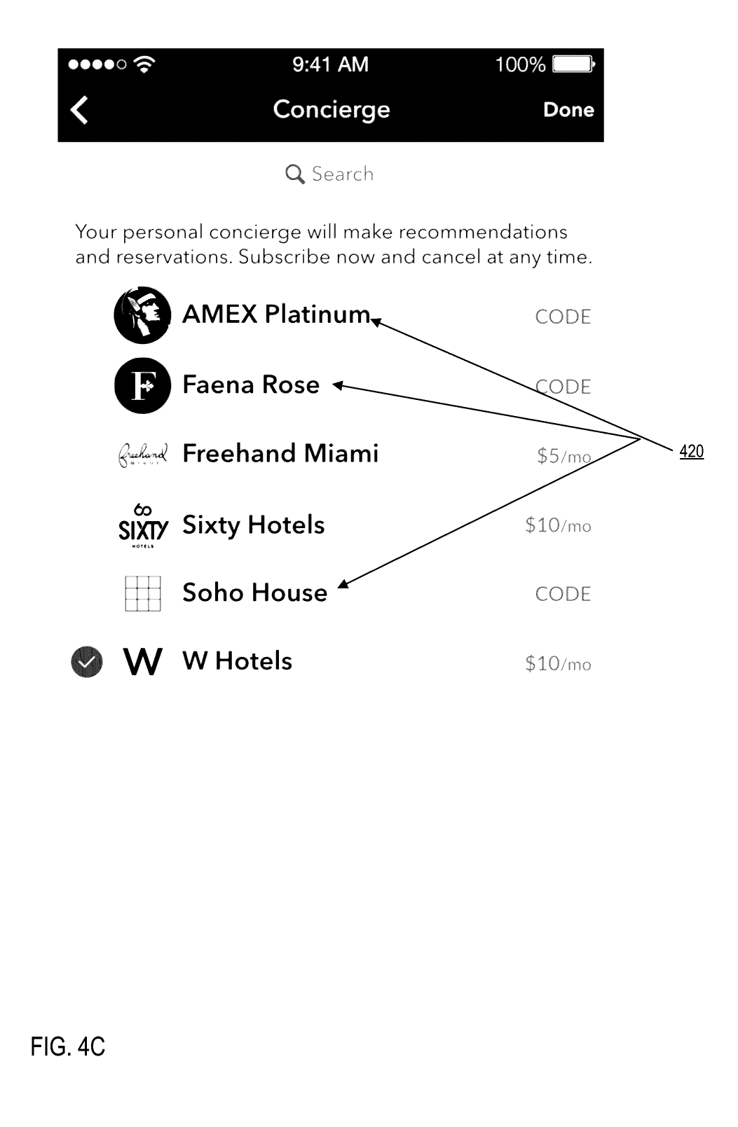

At block 305, a selection of one or more contacts, users, etc., can be received, such as in a manner described herein. In certain implementations, such a selection can be received from a first device (e.g., user device 102A as depicted in FIG. 1) such as may be associated with a first user (e.g., a content requesting user). By way of further illustration, various aspects of the disclosed techniques/technologies can be initiated by a user (e.g., a requesting user) selecting one or more other users/contacts. For example, FIG. 4A depicts an exemplary user interface (e.g., as generated/provided by dynamic messaging application 292 executing on device 102 and presented via a display, e.g., a touchscreen display) in which a user has selected several contacts 410, such as from their personal contact list (e.g., as stored on their mobile device 102 and/or maintained by a third-party platform 150). As described and depicted herein, in certain implementations such users can be selected by a requesting user (e.g., via dynamic messaging application 292 executing on device 102) to be recipients of one or more messages that the requesting user is to compose (e.g., a request for a recommendation for a particular type of restaurant in a particular city or neighborhood).

Additionally, at block 315, one or more additional contacts, such as those that may be relevant to the one or more request parameters (such as those parameters identified at block 310, as described below—e.g., a location, type of cuisine, etc.) can be identified. That is, in certain implementations, in addition to and/or instead of receiving a selection of existing contacts by the requesting user (that is, contacts that have been previously associated with the user, e.g., by virtue of the presence of contact information—e.g., a user ID, email address, phone number, etc.,—within a contact list maintained on the user device 102 and/or by a third party platform 150—e.g., a contact, connection, ‘friend,’ etc., within a social networking platform), the described technologies can also enable the requesting user to select from various other users, experts, or entities, such as those to which the requesting user may not otherwise have been previously connected (and thus may not otherwise appear in the requesting/selecting user's contact list) and to direct composed message(s) to such users/entities.

Accordingly, at block 320 an option to transmit list of content items (e.g., potential restaurants to receive feedback on, as described herein) and/or a request that generates an associated custom list to such additional contacts can be provided at the first device (that is, the requesting user's device). For example, the option to select and message users, experts, and/or entities which have (or may have) particular subject matter expertise, knowledge, connections, ability, etc., such as with respect to a particular region, topic, area, industry, etc. such as the ability to provide services such as reservations or preferential access, etc.) can be provided to a requesting user (e.g., via dynamic messaging application 292 executing on device 102), such as is depicted in FIG. 4B and FIG. 4C, showing respective interfaces depicting various ‘premium’ or ‘concierge’ individuals/entities 420 that a requesting user can select in order to direct messages to such users/experts/entities. It should be understood that, in certain implementations, the list of individuals/entities to be presented to the requesting user can be prioritized, ordered, and/or filtered based on one or more factors, characteristics, and/or considerations. For example, the list of individuals/entities can be prioritized, ordered, and/or filtered based on a location of the requesting user (e.g., based on geographic coordinates as received from GPS receiver 245C, an IP address as received via communication interface 250, and/or any other such inputs based upon which a location of the device can be determined), in order to depict to the requesting user those individuals/entities that are likely to be capable of providing valuable responses with respect to the location at which the requesting user is currently determined to be. In other implementations, such a list of individuals/entities can be prioritized, ordered, and/or filtered based on various inputs provided by the requesting user (e.g., the type of cuisine they are looking for, the neighborhood they are searching in, etc.). It should also be noted that, in certain implementations, various access charges (e.g., monthly charges, per-use charges, etc.) may be associated with the selection of such users/entities.

At this juncture it should be noted that, in certain implementations a platform (e.g., a ‘marketplace’) can be provided whereby users, entities, etc., (such as those with particular knowledge, experience, access, etc., to a particular area, sector, etc.) can promote their expertise to requesting users. For example, such users, entities, etc., wishing to provide services (e.g., by providing recommendations or otherwise responding to questions) to requesting users can be listed for selection as depicted in FIGS. 4B and 4C. In certain implementations such users/entities may be listed based on their experience, qualifications, reputation, etc., while in other implementations such users/entities may be listed based on the payment of certain fees (e.g., one-time, monthly, etc.), in addition to and/or instead of the prioritization, ordering, and/or filtering described above.

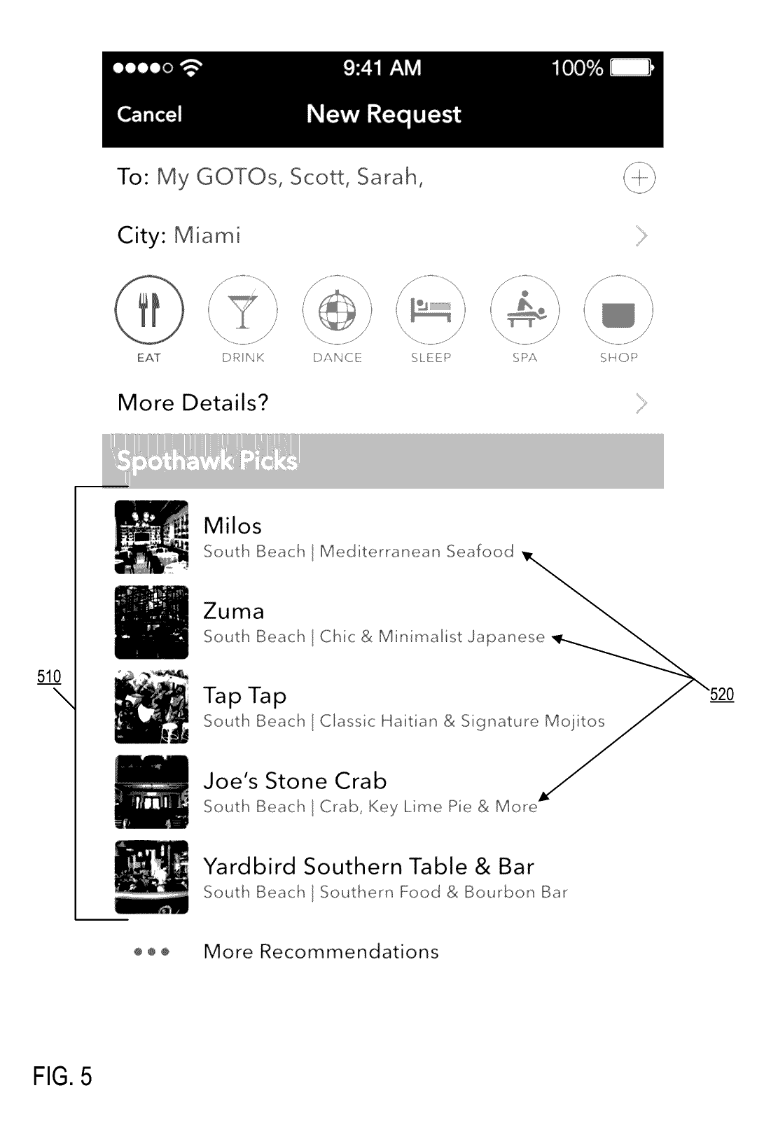

At block 325, one or more content items that are associated with the referenced contact(s) and/or associated with/relevant to the referenced request parameter(s) can be identified. In certain implementations, such content items (e.g., restaurants) can be identified based on the selection of the referenced contacts (e.g., at block 305) and/or the received request parameters (e.g., at 310). At block 330, a list of the referenced content items can be provided, e.g., to the first device (e.g., the requesting device) and/or to one or more receiving devices, such as those that correspond to the selected contacts. By way of further illustration, FIG. 5 depicts an exemplary interface (e.g., as generated/provided by dynamic messaging application 292 executing on device 102 and presented via a display, e.g., a touchscreen display) through which a requesting user can generate a content request (e.g., a request for a recommendation of a restaurant, service, etc., such as in a particular location). As shown in FIG. 5, upon selecting various users/contacts/entities (e.g., as described with respect to FIGS. 4A-C), a list, such as a suggested/curated, custom list 510 of content entries 520, such as establishments can be generated. As described herein, such a list can be generated based on various preferences, histories, recommendations (e.g., previous messages), etc., associated with the selected users/contacts/entities (such as may be stored, for example, in data repository 140 of server 120). In doing so, dynamic messaging engine 130 and/or server 120 can identify content/establishments that are associated with the selected users/contacts/entities (and/or with respect to which such users/contacts/entities have previously provided feedback with respect to or otherwise composed messages regarding, etc.), and present such content, establishments, etc., to the requesting user, even before the requesting user provides any further input/selections. In doing so, the focus of the requesting user's search and/or the messaging request to be composed by the requesting user can be further focused towards content, establishments, etc., that the selected users/contacts/entities, etc., have already been determined to be familiar with, have already provided feedback with respect to, etc. It should be noted that, in certain implementations, the list 510 as depicted in FIG. 5 can be a curated, custom list. That is, as noted above, such a list can be generated and presented to the requesting user based on various preferences, histories (e.g., previous instances in which such a user recommended, visited, frequented a particular establishment or type of establishment, etc.), recommendations (e.g., previous messages), personal list(s) (which the user may curate for themselves, e.g., to maintain a list of restaurants they are interested in visiting in the future), etc., associated with the requesting user and/or the selected users/contacts/entities. Accordingly, it can be appreciated that such a list 510 can be custom or particularly suited/tailored to the preferences, history, etc., of the requesting user (such that, for example, another user that generates a comparable content request, even for the same or similar category, cuisine, etc., within the same location, may be presented with different content in list 510, on account of the fact that such a user is likely to have different preferences, history, etc.).

As referenced above, at block 310, one or more request parameters can be received, e.g., from the first device (e.g., the device from which the selection of contact(s) was received at block 305). For example, upon selecting the referenced users/contacts/entities, the requesting user can then compose/initiate a messaging request. As shown in FIG. 5, in certain implementations such a content request can be associated with, focused on, and/or limited to one or more parameters. For example, such a request can be focused towards a particular type of establishment, e.g., restaurants, bars, nightclubs, hotels, stores, etc. and the request can be further refined based on a location (e.g., a city, a particular neighborhood, the user's current location, etc.). By way of illustration, as shown in FIG. 5, upon selecting the ‘eat’ category and a location (e.g., ‘Miami’), a list of one or more establishments meeting the selected criteria (e.g., restaurants in Miami) can be generated and presented to the user (e.g., ‘Milos,’ ‘Zuma,’ etc.). It should be understood that such establishments can be selected and/or prioritized based on any number of factors/considerations. For example, ratings for various establishments can be requested/received (e.g., from external sources, e.g., ratings guides, etc.). By way of further example, as users utilize the disclosed technologies to provide ratings/suggestions for various establishments (e.g., in response to other requests) or add establishments to certain personal lists, such feedback can be stored (e.g., in data repository 140) and considered/utilized when curating future lists, such as suggested, curated lists of establishments (such as is depicted in FIG. 5 and described herein). By way of yet further example, various preferences of the requesting user (which may be affirmatively indicated by the user and/or determined over time based on observed activity/behavior associated with the user) can also be accounted for in generating a list such as a suggested, curated list of establishments to be incorporated within the message request. Thus, by way of illustration, with respect to a request coming from user that has indicated a preference for seafood (e.g., based on previous activity/history), seafood restaurants can be prioritized when curating a list such as a suggested, curated list of establishments for the content request (such as is shown in FIG. 5 and described herein). Additionally, as previously noted, in certain implementations, a list such as a suggested, curated generated list (based on the selection of recipients) can be searched, appended, refined, filtered, and/or prioritized based on the further selections provided by the requestor and can also be added to dynamic list(s), such as those generated as described herein.

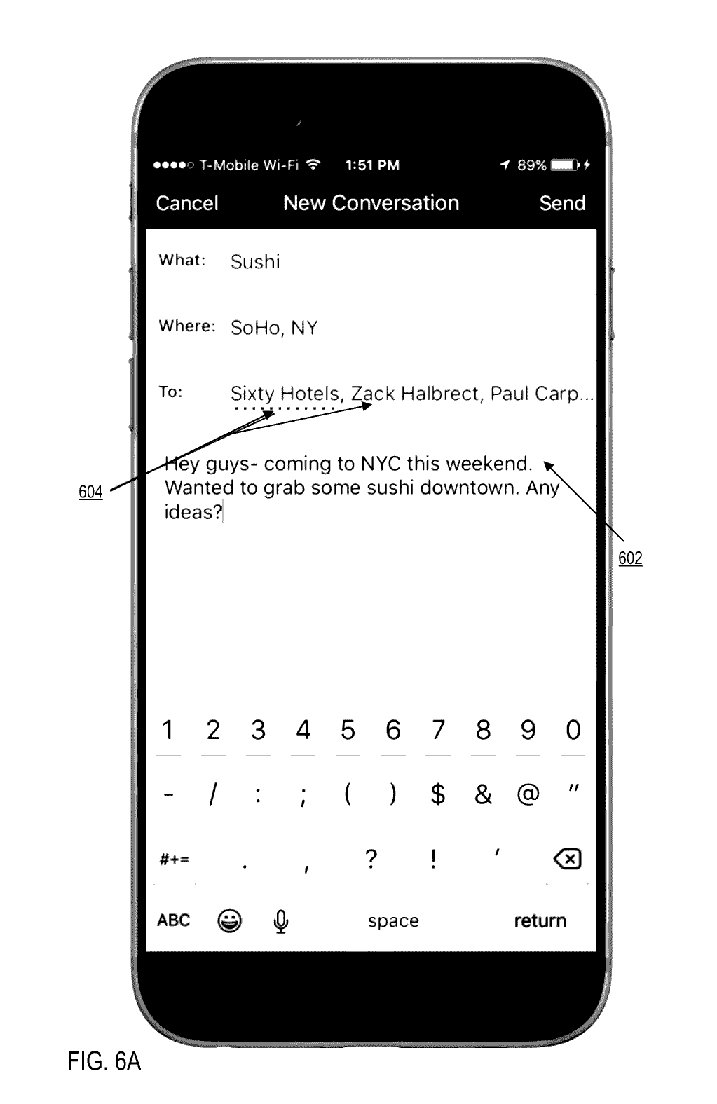

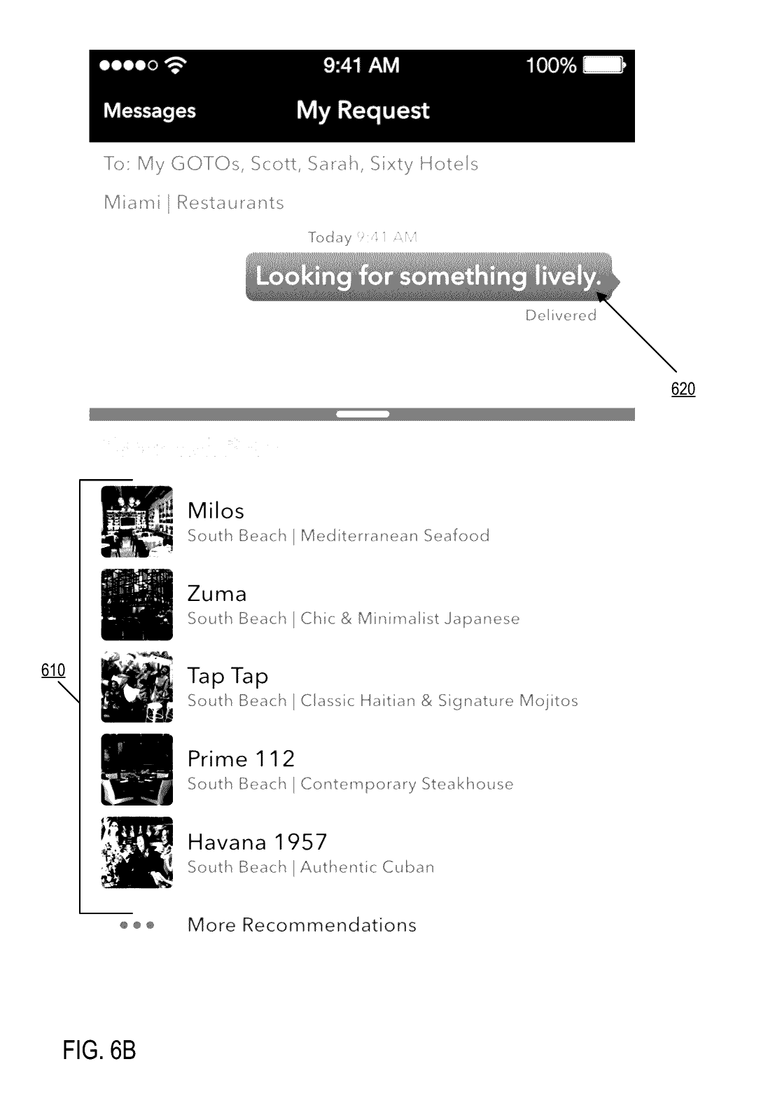

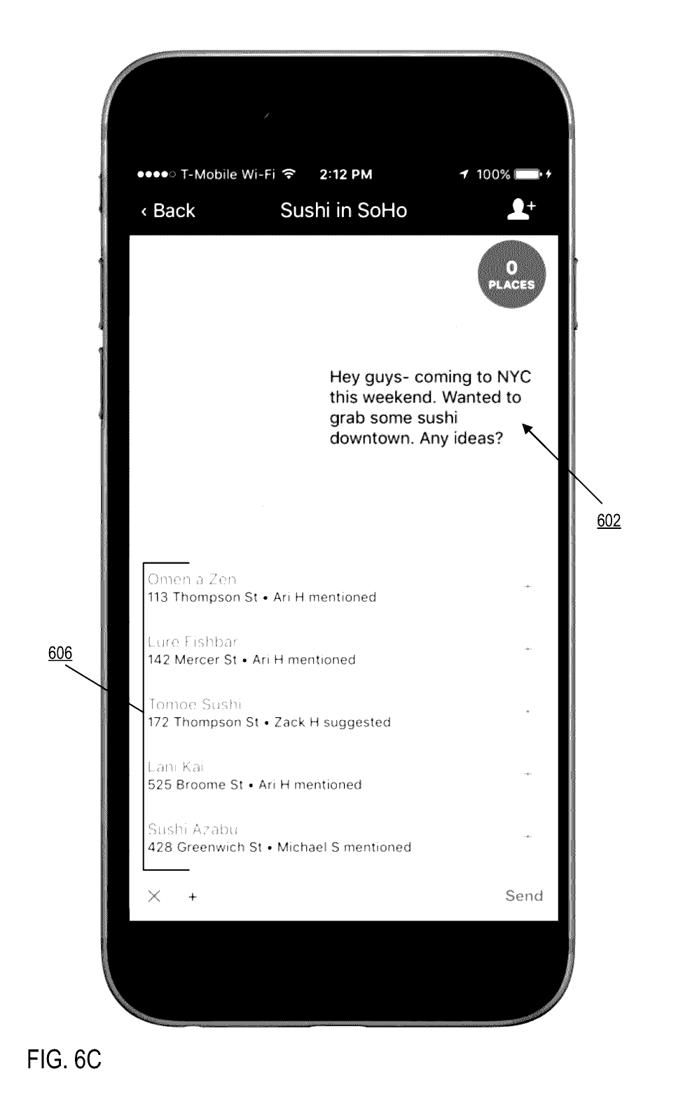

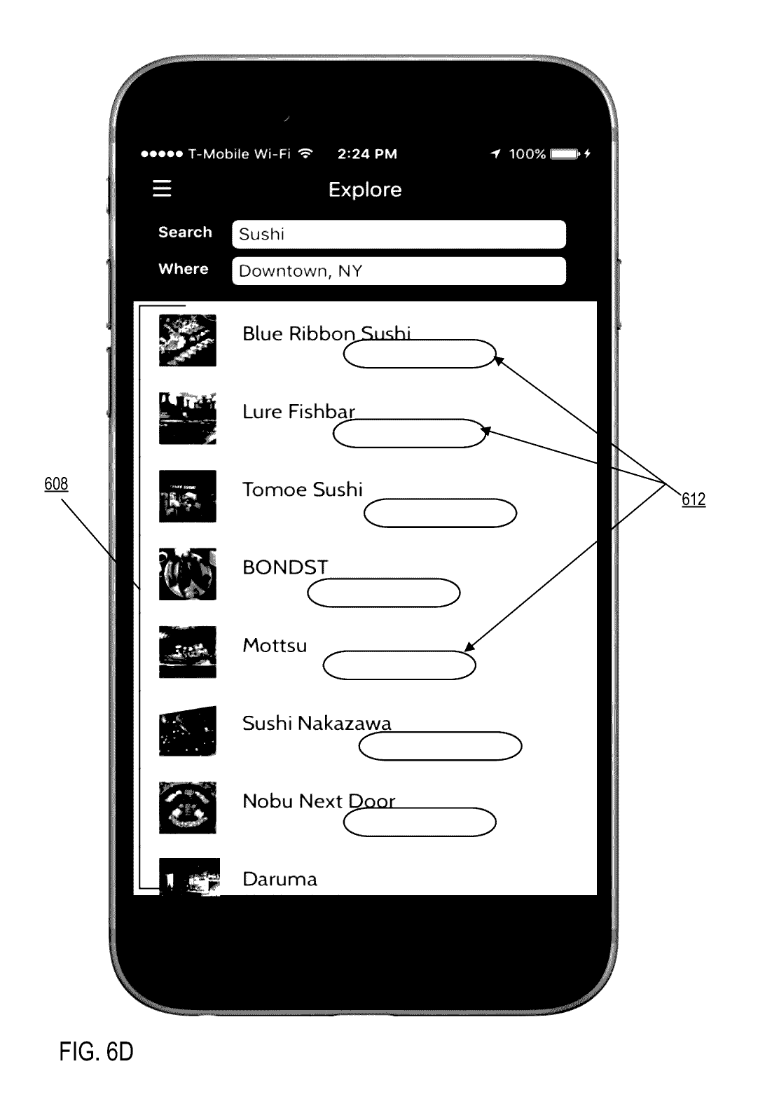

In certain implementations, in addition to and/or in lieu of being presented with a list such as an initially curated, suggested list of content entries 520, (e.g., list 510 of establishments as identified in a manner described above and as depicted in FIG. 5A), the requesting user can also generate/provide input (e.g., textual input, graphical input, etc.) based upon which such a curated list of content, establishments, etc., can be generated. For example, FIG. 6A depicts an exemplary interface (e.g., as generated/provided by dynamic messaging application 292 executing on device 102 and presented via a display, e.g., a touchscreen display) within which a requesting user is composing a content request 602 (e.g., a request for a recommendation of a restaurant, service, etc., such as the message “Hey guys—coming to NYC . . . Wanted to grab some sushi . . . ,” as shown) which may be directed to various recipients 604 (e.g., ‘Sixty Hotels,’ ‘Zack,’ etc.), as shown. As is also shown in FIG. 6A, in certain implementations the requesting user can specify a topic (“What: Sushi”) and/or a location (“Where: SoHo, NY”), as shown. As described in detail herein, based on the referenced inputs provided by the requesting user (e.g., the topic, e.g., sushi, the location, e.g., SoHo, the intended recipients of the message, and/or the content of the message itself), a list such as a suggested list of content, e.g., establishments, etc., can be generated and presented to the requesting user, even, for example, in advance of the receipt of any additional inputs from the intended recipient(s). As noted, in doing so the requesting user can be provided with a curated or filtered list of content, e.g., establishments, that are relevant to the provided request, even in advance of the intended recipients providing any affirmative feedback, based on the fact that the described technologies can determine/identify the recipients to which the requesting user is directing the referenced request for feedback.

At block 335, various inputs/feedback can be received with respect to a list such as the curated, suggested list from the first device (e.g., the requesting device) and/or from the various receiving devices. For example, in certain implementations one or more of the referenced users can add content item(s) from the referenced suggested list into the messaging conversation and/or another list such as a dynamic list, as will be described. At block 340, in response to such inputs/feedback received from such device(s), various aspects of the presentation of the dynamic list can be adjusted (e.g., as presented at the requesting device and/or the receiving device(s)) (e.g., by adding, removing, and/or adjusting the relative position of the various content items within the dynamic list). By way of further illustration, in certain implementations the referenced content request can further incorporate various types of additional input as part of the message to the specific users/contacts/entities, such as in order to further specify the nature of the user's request. For example, as shown in FIG. 6B, the user can provide specific textual input (‘Looking for something lively’) that can further elaborate upon the type of establishment the user is seeking. Such input(s) can be processed, parsed, and/or analyzed, such as in order to identify various keywords (e.g., ‘lively’) and/or any other such indicators that reflect further aspects of the content request. The initial curated list of establishments (such as that depicted in FIG. 5) can then be further filtered, refined, and/or weighted based on the referenced inputs, keywords, and/or indicators. For example, FIG. 6B depicts an exemplary interface (e.g., as generated/provided by dynamic messaging application 292 executing on device 102 and presented via a display, e.g., a touchscreen display) within which a requesting user has provided a content request 620 (e.g., a request for a recommendation of a restaurant, service, etc., such as in a particular location). As depicted in FIG. 6B, upon receiving the referenced input from the requesting user (‘Looking for something lively’), various other establishments can be incorporated into a list such as dynamic list 610 (e.g., ‘Prime 112,’ ‘Havana 1957,’ etc.), such as based on the fact that such establishments meet the same/complementary criteria reflected in the referenced input(s) (e.g., such establishments have been indicated/determined, e.g., based on previous reviews, to be ‘lively,’). Moreover, various establishments that may have originally been included in the curated list (such as is depicted in FIG. 5) can be eliminated and/or reduced (e.g., in their positioning/prominence) based on the referenced input(s). For example, having determined that the user is seeking a restaurant that is ‘lively,’ those establishments that are determined to be associated with characteristics that may not be compatible (e.g., those characterized as ‘quiet,’ ‘low-key,’ etc.) can be removed and/or de-prioritized within the list. It should be understood that in certain implementations the referenced characteristics (e.g., those that characterize a particular establishment) can be identified based on data received from a third-party platform (e.g., a third-party database, ratings platform, etc.) while in other implementations such characteristics can be identified based on content stored in data repository 140 and/or based on inputs/feedback received from the various users. For example, in a scenario in which various users of the described technologies have previously discussed, corresponded about, etc., a particular establishment and characterized it in various ways (e.g., referred to it as ‘quiet,’ ‘low-key,’ etc.), such a characterization can be stored in data repository 140 such that subsequent queries can utilize such a characterization in providing appropriate recommendations with respect to such an establishment.

By way of further illustration, data originating at a third-party payment platform, service, database, etc., can be utilized in dynamically generating and providing a list such as a curated, suggested list for content items to be included in a conversation. For example, it can be appreciated that a database of credit card transactions can include and/or otherwise reflect residence information (e.g., a home address, zip code, etc.) of various users/customers, and can further include/reflect purchases made by such users, including the name and/or type of establishment (e.g., department store, restaurant, gas station, etc.) as well as location information (e.g., address, zip code, etc.) associated with such an establishment. Accordingly, the referenced credit card transaction information can be processed to identify those restaurants within a particular geographic area (e.g., within a particular zip code) that are frequented by customers who live within and/or near the same zip code (thus reflecting restaurants that are favored or preferred by local residents). As such, upon receiving a request from a user with respect to which it can determined that the user is interested in/has a preference for establishments that are ‘local favorites’ (e.g., based on previous requests received from such a user, based on previous behavior exhibited by and/or observed with respect to such a user, etc.), such ‘local favorites’ (that is, those establishments that are frequented by customers determined to be residing within a particular location and/or within a defined proximity thereto) can be identified/determined and provided to the requesting user, e.g., within a curated, suggested list, as described herein.

It can be appreciated that by dynamically curating a list of establishments while the user is inputting the request itself (e.g., the type of establishment, location, and other details), the user may be able to select an establishment even without messaging or reaching out to the initially selected recipients and/or prior to receiving responses from such recipients. Accordingly, in certain implementations, at block 345, a content request (e.g., a search query for a restaurant) can be received from another device. Such a content request may include one or more common parameters as the request referenced above, e.g., at block 310. At block 350, based on the referenced common parameters between the referenced previous content request and the current content request (e.g., in a scenario in which such requests are for the same or similar cuisine, within the same or similar location, etc.), the inputs/feedback received with respect to a curated, suggested list (e.g., at 335) can be identified. At block 355, an updated, curated, suggested list of content items can be provided to the requesting device which can include various content items that were also previously included in the initial curated, suggested list. For example, FIG. 6C depicts an exemplary interface (e.g., as generated/provided by dynamic messaging application 292 executing on device 102 and presented via a display, e.g., a touchscreen display) within which a requesting user has composed a content request 620 (e.g., a request for a recommendation of a restaurant, service, etc., such as is depicted in FIG. 6A and described herein) and transmitted such a request to various users, entities, etc. As shown in FIG. 6C, a curated list 606 of establishments can be generated based on the various criteria/characteristics provided by the requesting user (e.g., the type of cuisine, location, etc.) as well as based on previous messaging/feedback instances associated with the various intended/directed recipients of the content request or that a user has added the establishment to a personal list (e.g., a list of content items, e.g., establishments, that a user can maintain (e.g., for future reference), such as by selecting such establishments when viewing them within the described curated lists (and/or through any other such interface). For example, as shown in FIG. 6C, the restaurant ‘Omen a Zen’ can be included in curated list 606 by virtue of the fact that it was previously mentioned (e.g., in a previous correspondence) by user ‘Ari H’ (who may or may not be one of the intended recipients of the referenced content request) while the restaurant ‘Tomoe Sushi’ can be included in curated list 606 by virtue of the fact that it was previously suggested (e.g., in a previous correspondence) by user ‘Zach H’ (who is one of the intended recipients of the referenced content request). It should also be noted that the manner in which the content (e.g., restaurant information) is prioritized/ranked within the described list(s) can account for those user(s) with respect to which the content request is directed. For example, content (e.g., restaurant suggestions) that originates from and/or is otherwise associated with user(s) with respect to which the content request is directed can be prioritized (e.g., above content that originates from and/or is otherwise associated with user(s) with respect to which the content request is not directed).

Additionally, in certain implementations the described technologies can be utilized to enable a requesting user to search, browse, etc., in advance of and/or in lieu of initiating a content request to other user(s). For example, FIG. 6D depicts an exemplary interface (e.g., as generated/provided by dynamic messaging application 292 executing on device 102 and presented via a display, e.g., a touchscreen display) within which a requesting user can browse or search for content—here, searching for ‘Sushi’ in ‘Downtown, NY,’ as shown. As shown in FIG. 6D, a curated list 608 of establishments (‘Blue Ribbon Sushi,’ ‘Lure Fishbar,’ etc.) can be generated and provided to the requesting user. It should be understood that such establishments can be identified and/or provided based on content received from a third-party service or platform (e.g., a database that maintains locations, information, reviews, etc., of restaurants and/or other establishments) as well as based on previous messaging/feedback instances associated with various other users of the described application/technologies (e.g., those users determined to be associated with the requesting user—e.g., based on a determination that such users are present in a contact list, social media profile, etc. of the requesting user, and/or have previously corresponded with the requesting user via the described technologies). For example, as shown in FIG. 6D, each of the restaurants included in list 608 can further include an indicator 612 reflecting which of the referenced users has previously commented or provided feedback with respect to a particular establishment or added that establishment to a personal list, as well as the context in which such feedback has been provided (e.g., ‘Ari H mentioned,’ ‘Zack H suggested,’ whether such user has previously dined or visited the establishment, the frequency and/or recency with which such a user has visited the establishment, etc.). In doing so, the requesting user can utilize feedback previously provided by other users with respect to certain establishments when reviewing results provided in a search or browse interface. Additionally, by providing an indication of which user(s) have previously commented regarding, provided feedback with respect to, suggested, etc., a particular establishment (e.g., in previous correspondences/communication sessions), the requesting user can more effectively identify those users that are likely to be capable of providing feedback or otherwise evaluating such options. For example, based on a determination that a particular user mentioned a particular restaurant in a previous correspondence, the requesting user can direct an inquiry to such a user, e.g., with respect to whether such an establishment is appropriate for a romantic dinner, has a ‘lively’ ambiance, etc.

Moreover, in certain implementations the requesting user can also further curate the dynamic list. By way of illustration, in a scenario in which a user identifies an establishment within the curated, suggested list that he/she is not interested in (e.g., because they recently visited this establishment or it is not appropriate/relevant for this particular search, etc.), the user can elect to remove such an establishment from the curated, suggested list (e.g., using a ‘swipe’ gesture). In doing so, the requesting user can further ensure that he/she receives feedback specifically with respect to establishments that are likely to be appropriate/of interest for each specific request.

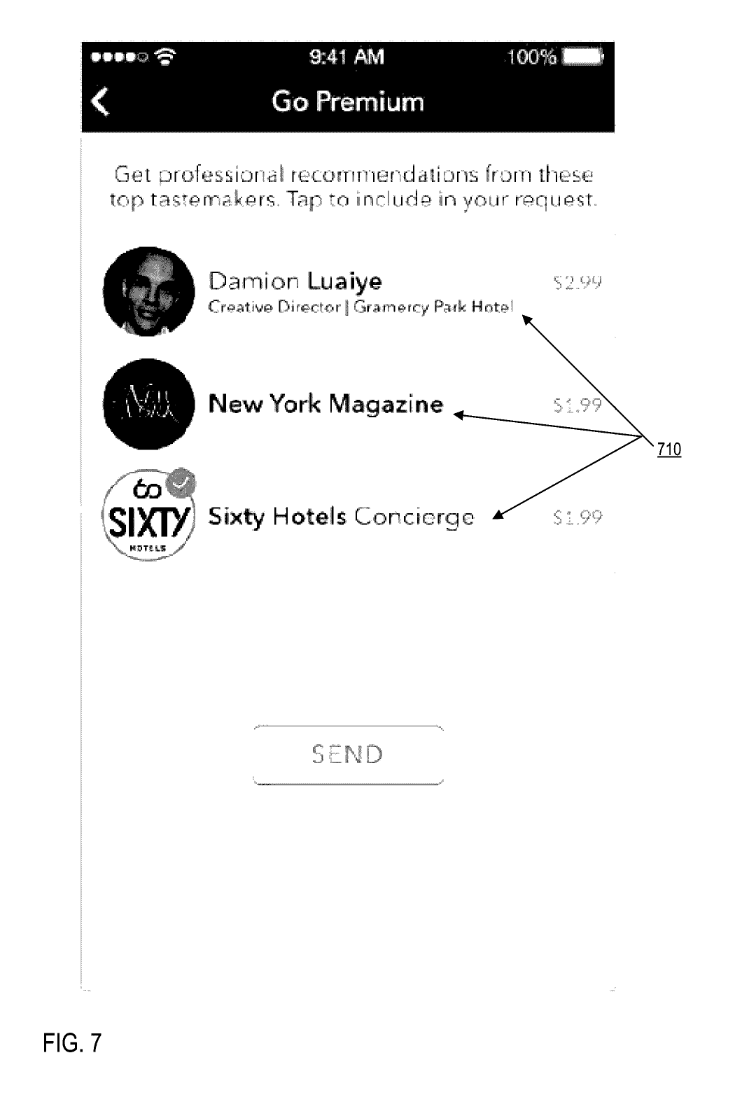

Additionally, in certain implementations the requesting user can be presented with the option to send their request to one or more authorities/entities that have been identified as having particular knowledge/expertise in a particular venue type, location, etc. In certain implementations, the requesting user may be provided with the option to select entitie(s) that intend to market their services to that requesting user, or the requesting user may be provided with the option to purchase this access. FIG. 7 depicts an exemplary user interface (e.g., as generated/provided by dynamic messaging application 292 executing on device 102 and presented via a display, e.g., a touchscreen display) within which the requesting user is presented with the option to transmit his/her content request to various authorities/entities 710. In certain implementations, certain authorities/entities can be identified, selected, and/or recommended based on various parameters associated with the content request. For example, based on the location/category specified in the content request, those authorities/entities that specialize in the same (or similar) location/category can be selected, recommended, and/or prioritized. Moreover, in certain implementations those authorities/entities that can be determined to have particular experience/insight into one or more of the establishments included in the curated list included in the content request (e.g., based on previous messages/recommendations provided by the particular authority/entity, based on activity history of the authority/entity, such as may reflect that the authority has visited one or more of the recommended establishments) can be selected, recommended, and/or prioritized.

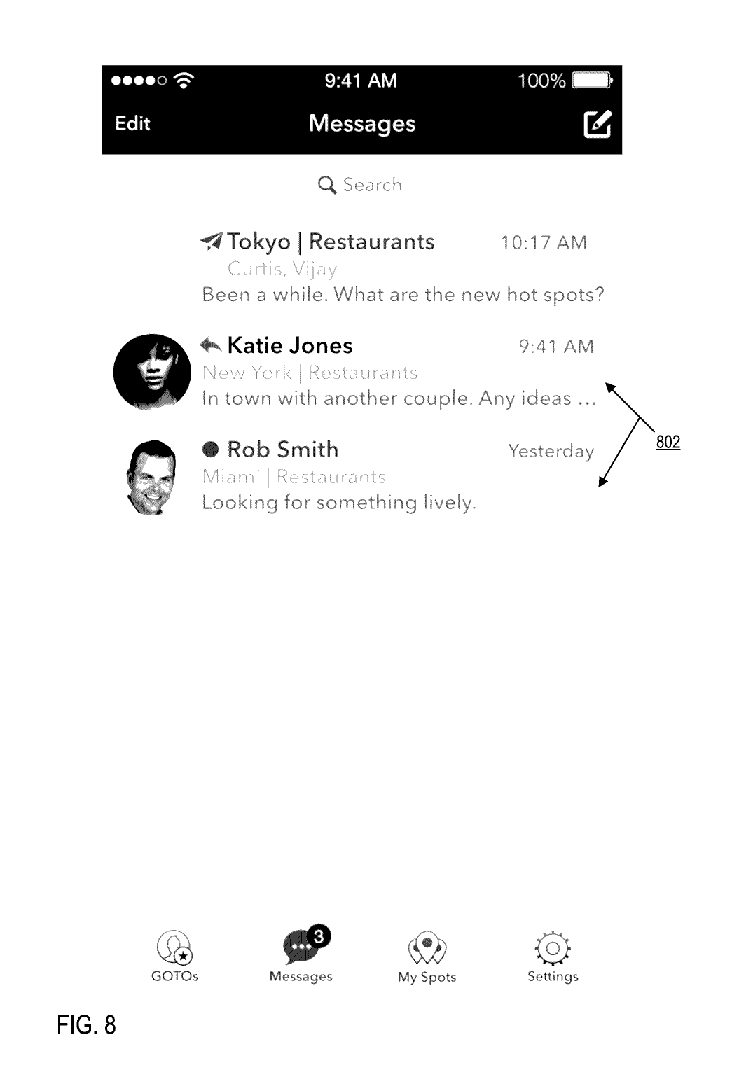

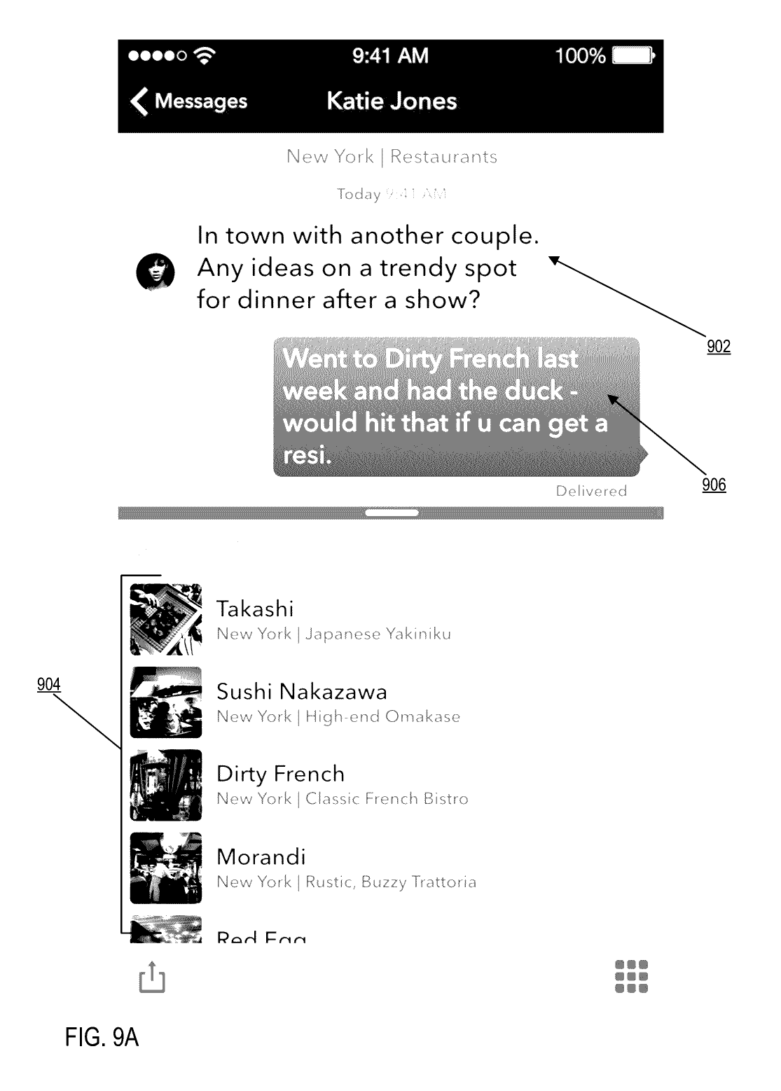

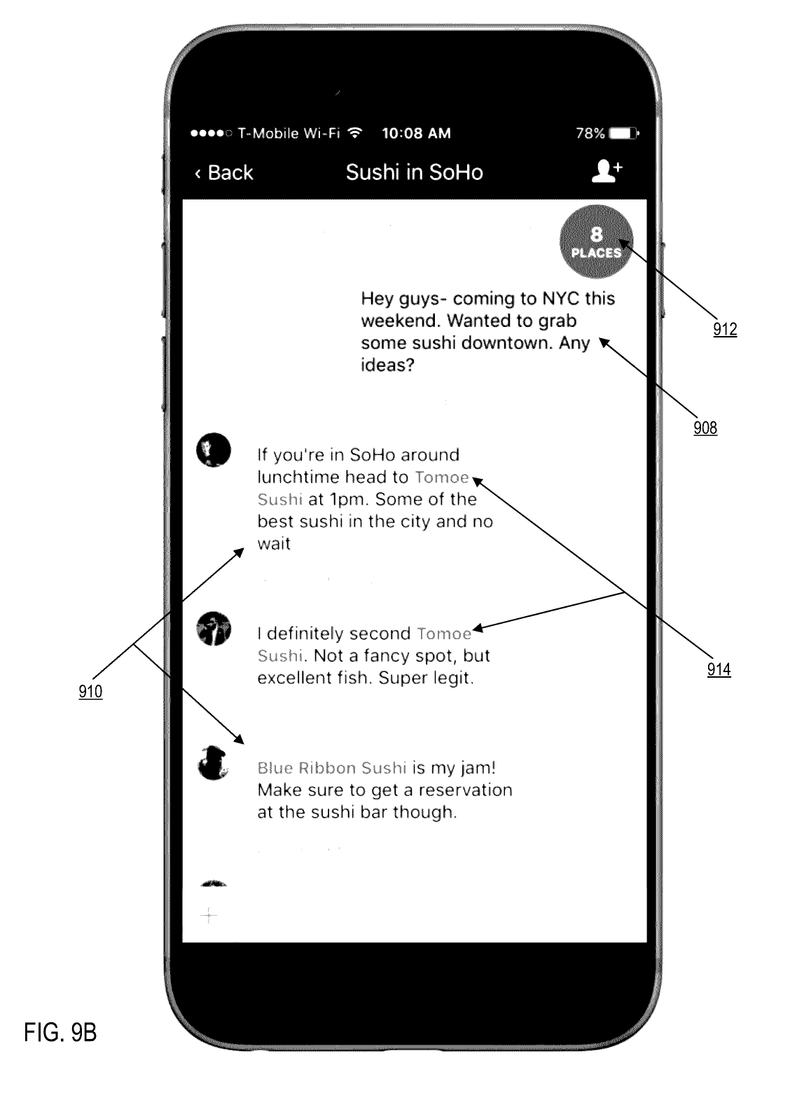

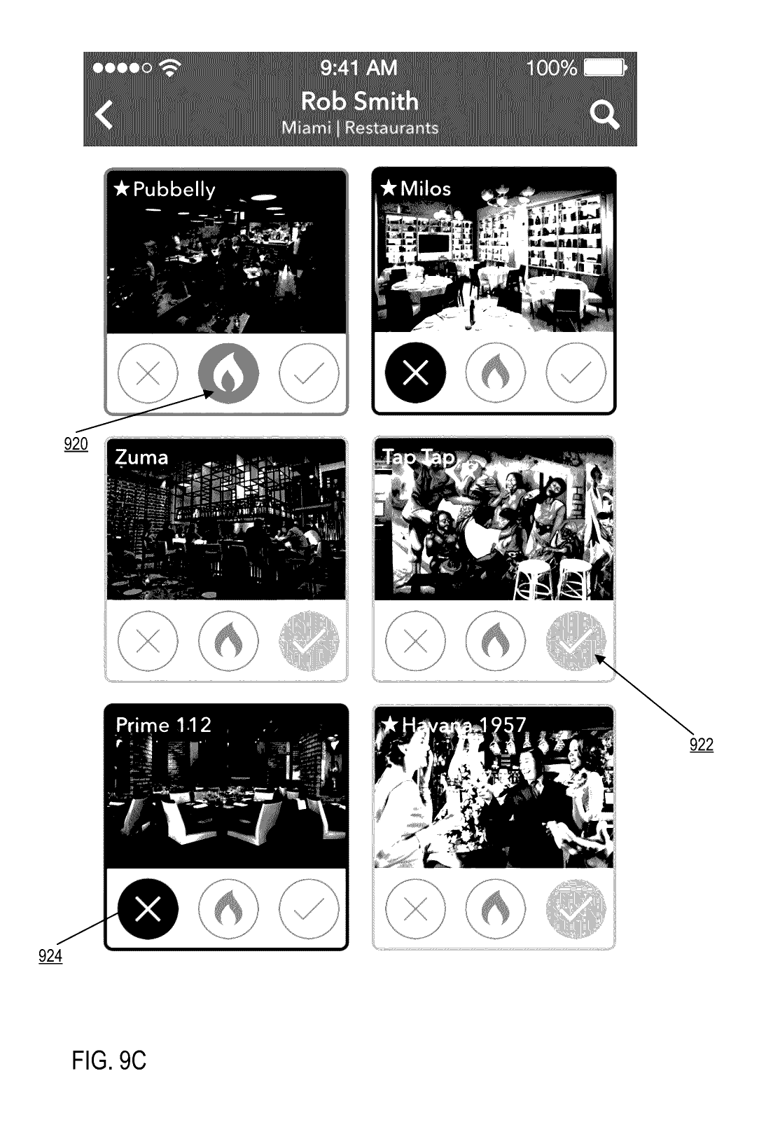

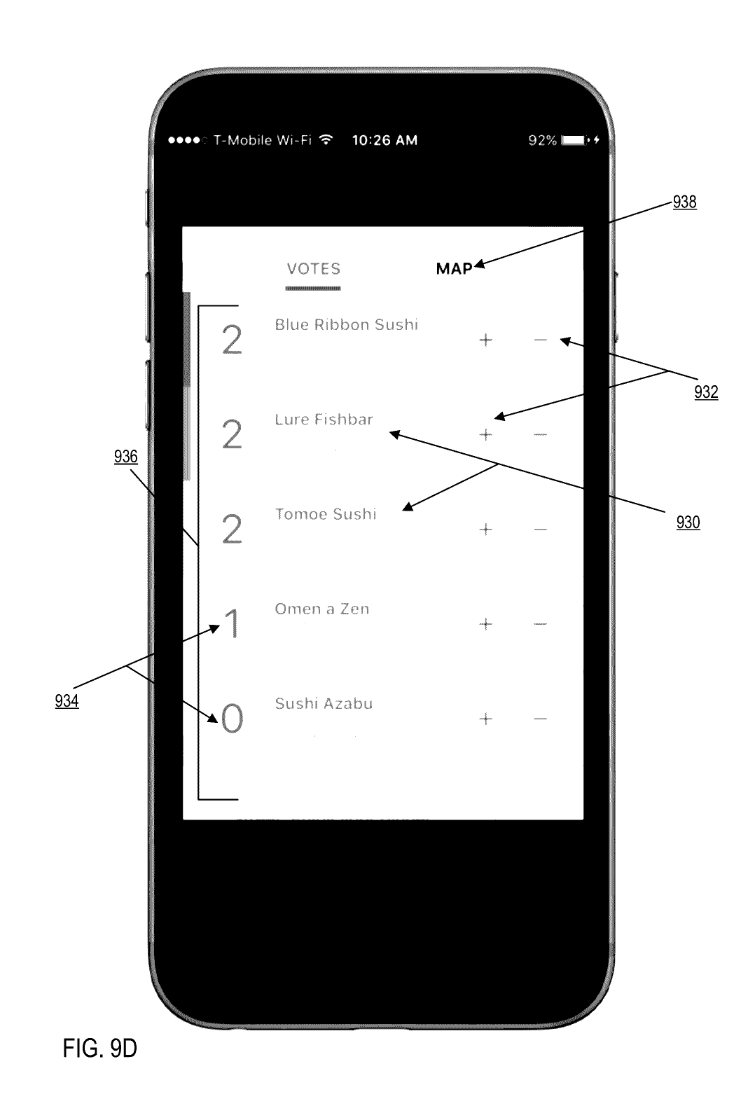

FIG. 8 depicts an exemplary interface (e.g., as generated/provided by dynamic messaging application 292 executing on device 102 and presented via a display, e.g., a touchscreen display) showing messages (an ‘inbox’ and an ‘outbox’) of a receiving user (i.e., a user who has received a content request sent by a requesting user). Upon selecting one of the items 802 in the ‘inbox’ (e.g., from ‘Katie Jones’), the receiving user can, for example, be presented with the content request 902 and the curated list of venues 904 (each of which can be, for example, a selectable hotlink that, when selected, can provide further information regarding the selected establishment), such as is depicted in FIG. 9A. As depicted in FIG. 9A, the receiving user can provide a response/feedback 906 to the requesting user, such as in the form of a text message response.

FIG. 9B depicts a further exemplary interface (e.g., as generated/provided by dynamic messaging application 292 executing on device 102 and presented via a display, e.g., a touchscreen display) in which various receiving user(s) can correspond with the requesting user, e.g., regarding the content request submitted/transmitted by the requesting user. As shown in FIG. 9B, the content request 908 (I-ley guys . . . ′) can be depicted, followed by various responses 910 provided by the receiving users. It should be noted that a selectable control, link, etc. 912 (‘8 places’) can be provided, upon selection of which the various users/participants in the correspondence can review a list such as a dynamically curated list that has been generated with respect to the content request (e.g., list 606 as depicted in FIG. 6C and/or list 608 as depicted in FIG. 6D and as described herein). That is, as described above, upon receipt of a content request 908 from a requesting user, each of the users/participants in a communication session/correspondence (e.g., the requesting user and the receiving user(s)) can be presented with a suggested/custom list of content entries (e.g., establishments) that are determined, for example, to be relevant to the parameters of the content request as well as relevant to the particular user to which such a custom list is being presented (e.g., based on such a user's history, previous communications, etc., as described above). Accordingly, as also noted above, each user/participant in a conversation may be presented with a different suggested/custom list of establishments. Thus, having presented such respective custom lists to each user/participant, the referenced users can select (and/or provide further feedback regarding) the establishments present in that user's custom list. Upon receiving a selection of an establishment from a particular user's custom list, such a selected establishment can be added to and/or otherwise incorporated within another list such as a dynamic list. Such a dynamic list can be shared among the various participants in the communication session and can, for example, maintain a list of establishments that various user(s) have suggested and/or otherwise provided feedback regarding (e.g., in response to the content request). Thus, as noted above, receiving a selection of control/link 912 (‘8 places’) can be present such a dynamic list to the user for review. Further aspects of the referenced dynamic list are depicted in FIG. 9D and described below. Additionally, it should be understood that the various responses 910 can be annotated, e.g., with selectable links 914 that correspond to respective entries/establishments within the referenced curated lists. Upon selection of such link(s), the user can be provided with additional information regarding the corresponding establishment (e.g., location, photos, reviews, menus, reservations, hours, etc.) as well as previous conversations or actions that include/reference that establishment.

Additionally, as depicted in FIG. 9C, in certain implementations the receiving user can provide various types of additional curation with respect to the various establishments included in the curated list. For example, FIG. 9C depicts a further exemplary interface (e.g., as generated/provided by dynamic messaging application 292 executing on device 102 and presented via a display, e.g., a touchscreen display) in which the receiving user can highlight certain establishments as being highly desirable/ideal (e.g., by selecting a ‘fire’ icon 920 with respect to such establishments), while indicating that other establishments in the list are acceptable/meet the qualifications of the request (e.g., by selecting a ‘check mark’ icon 922) and/or do not meet the referenced qualifications or are otherwise not recommended (such as by selecting an ‘X’ icon 924). It should be understood that selecting of the ‘X’ icon (or providing any other such input, e.g., by ‘swiping left’ on the referenced entry when presented within a content list, etc.) does not necessarily mean that the responding user doesn't like the content presented from the curated, suggested list. Rather, such a selection can indicate that the responding user does not recommend the place for that specific request for that specific requesting user.

FIG. 9D depicts a further exemplary interface (e.g., as generated/provided by dynamic messaging application 292 executing on device 102 and presented via a display, e.g., a touchscreen display) in which the respective receiving user(s) can provide feedback with respect to the various establishments included in the curated, dynamic list (e.g., list 606 as depicted in FIG. 6C and/or list 608 as depicted in FIG. 6D and as described herein). As shown in FIG. 9D, the various establishments 930 included in the referenced list can be listed, together with selectable controls 932 with respect to which the receiving users can provide feedback (e.g., by increasing the voting tally associated with an establishment to indicate the user's recommendation of such an establishment, e.g., with respect to the request provided by the requesting user). As also shown in FIG. 9D, the tally (e.g., a sum or total 934) of the votes/feedback provided by the receiving users can be maintained and depicted, and the referenced list 936 can be sorted according to such tallies. Additionally, as shown in FIG. 9D, those users that have voted or otherwise provided feedback with respect to a particular establishment can be indicated. Moreover, as shown in FIG. 9D, a control 938 can be provided, which, when selected, can graphically depict the location of the various establishments in the list 936 on a map.

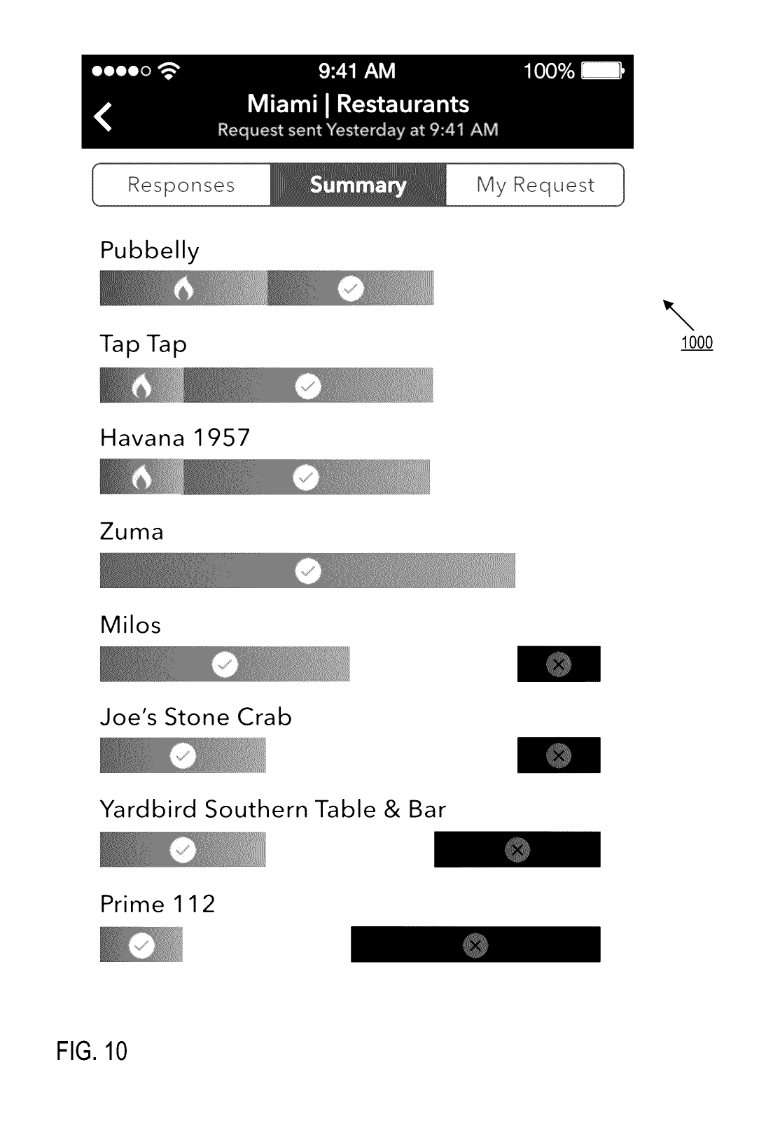

It should also be understood that, in certain implementations, the referenced feedback/response process can be performed by each of the recipients (such as those selected by the requesting user as depicted in FIGS. 4A-C and 7), and that a summary of such feedback can be generated and provided to the requesting user. In addition to the summary described and depicted with respect to FIG. 9D, FIG. 10 depicts an exemplary interface 1000 (e.g., as generated/provided by dynamic messaging application 292 executing on device 102 and presented via a display, e.g., a touchscreen display) showing such a further exemplary feedback summary. It should be understood that the interface in FIG. 10 also reflects that certain responding users may not have provided any feedback with respect to certain venues. As shown in FIG. 10, the various ratings/feedback provided by each of the receiving users can be aggregated and presented to the requesting user. Such a rating summary can enable the user to easily assess the collective feedback provided by multiple users with respect to various establishments. By way of illustration, as shown in FIG. 10, Tubbelly′ has been identified by several users as being ‘hot’ or highly appropriate/recommended with respect to the received request, ‘Zuma’ has been identified by many users as being acceptable/meeting the requirements of the received request, and ‘Prime 112’ has been identified by many users as not meeting the requirements/not being recommended with respect to the received request for that particular request for that particular requesting user.

At this juncture it should be noted that, in certain implementations, various lists described herein, including but not limited to the referenced curated, dynamic list (such as list 936 as depicted in FIG. 9D) can be dynamically updated (e.g., after the initial content request is sent by the requesting user, such as when content items are added to the conversation and/or the dynamic list). By way of illustration, in a scenario in which an initial request is sent to several receiving users, upon receiving feedback/recommendations from some of the referenced receiving users, the curated, dynamic list of establishments can be updated accordingly (e.g., by changing the priority/ordering of the list in accordance with such feedback). By way of further illustration, the users/participants can also subsequently modify the curated, dynamic list, and such modifications can be reflected in the presentation of the message(s) to the various recipients. For example, with respect to dynamic list 936 as depicted in FIG. 9D, it should be understood that upon receiving a selection (e.g., from one of the users/participants in a conversation) of another establishment to add to the dynamic list, the depicted list 936 can be updated to further incorporated such a selection.

It should also be noted that various other lists described herein may also, in certain implementations, be dynamically updated. For example, in a scenario in which a requesting user sends a content request to several recipients requesting feedback on several restaurants and then receives feedback from one recipient that strongly cautions the requesting user to avoid one of the establishments, the requesting user can remove the identified establishment from the curated list. Subsequently, those receiving users that view/respond to the request will not be presented with a curated list that includes the referenced establishment. In doing so, the user can further ensure that feedback being received is as relevant as possible to the specifics of the request.

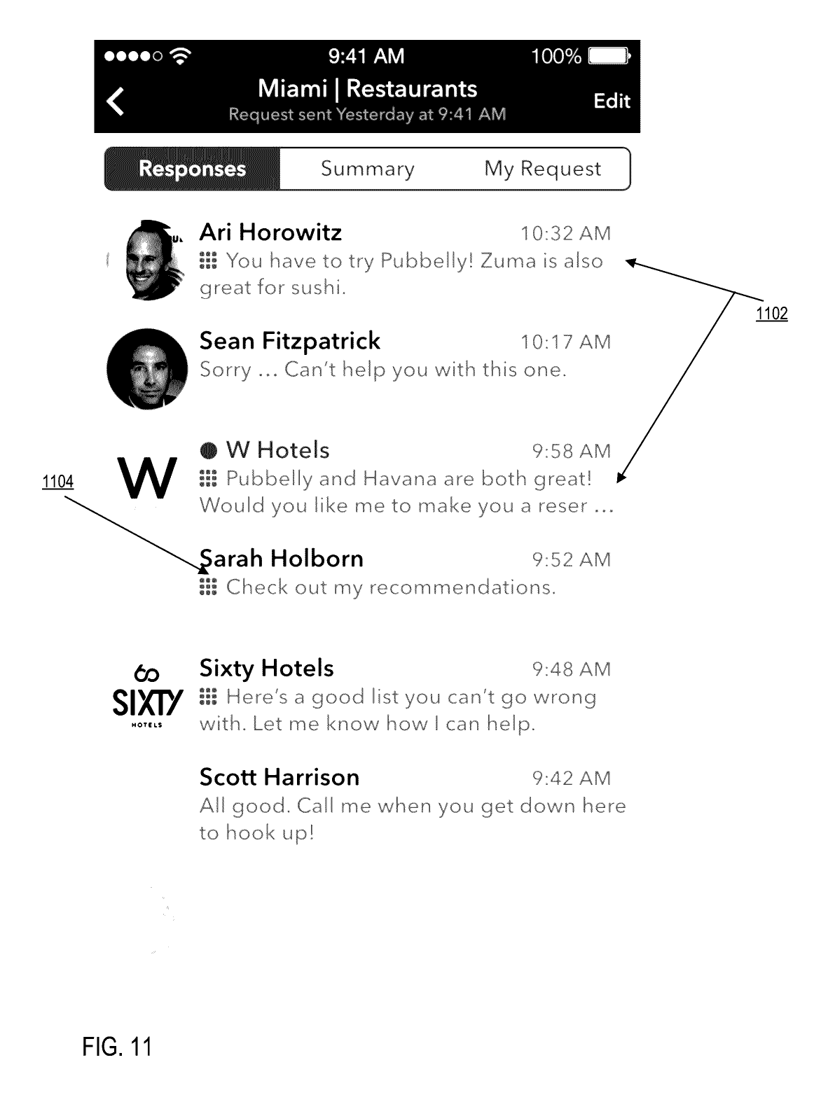

FIG. 11 depicts an exemplary interface (e.g., as generated/provided by dynamic messaging application 292 executing on device 102 and presented via a display, e.g., a touchscreen display) in which the individual responses/feedback 1102 provided by the various receiving users can be viewed by the requesting user. As shown in FIG. 11, those establishments that were identified by various users as being particularly relevant/appropriate or not relevant/appropriate may be referenced in each respective message, each of which can be, for example, a selectable hotlink that, when selected, can provide further information regarding the selected establishment. Further, a “box” icon 1104 (or any other such indicator) can reflect that the responding user (as shown in FIG. 11) has specifically curated the dynamic list for the requesting user.

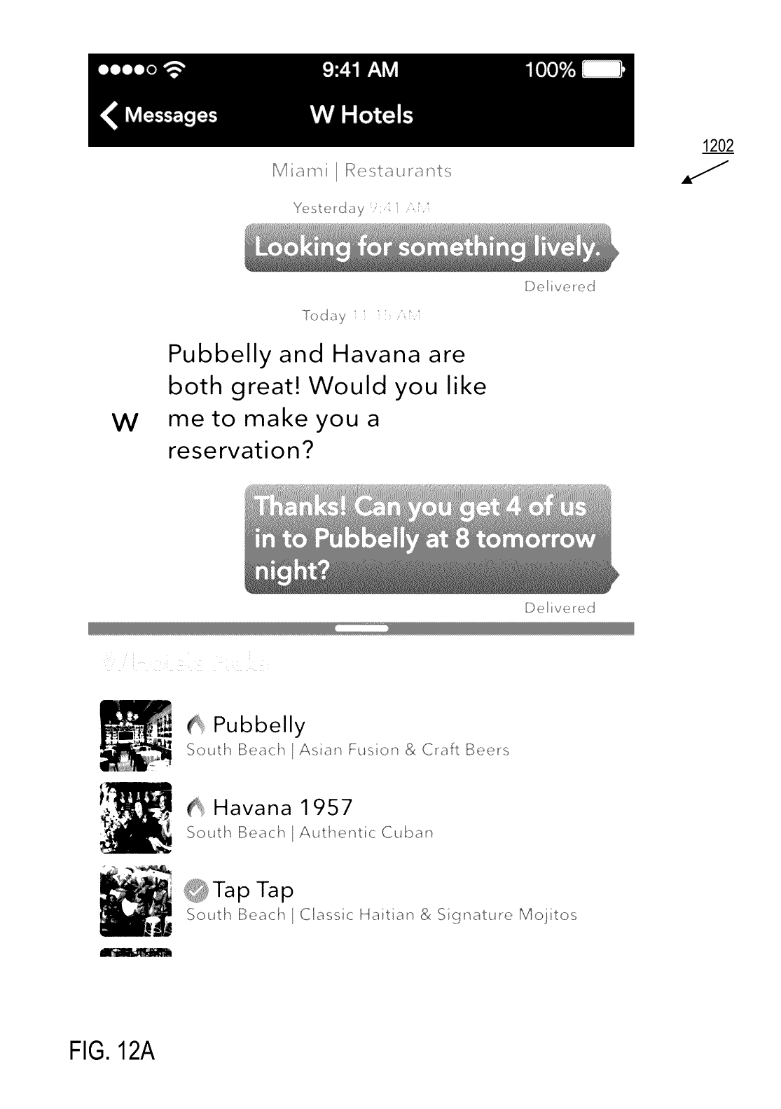

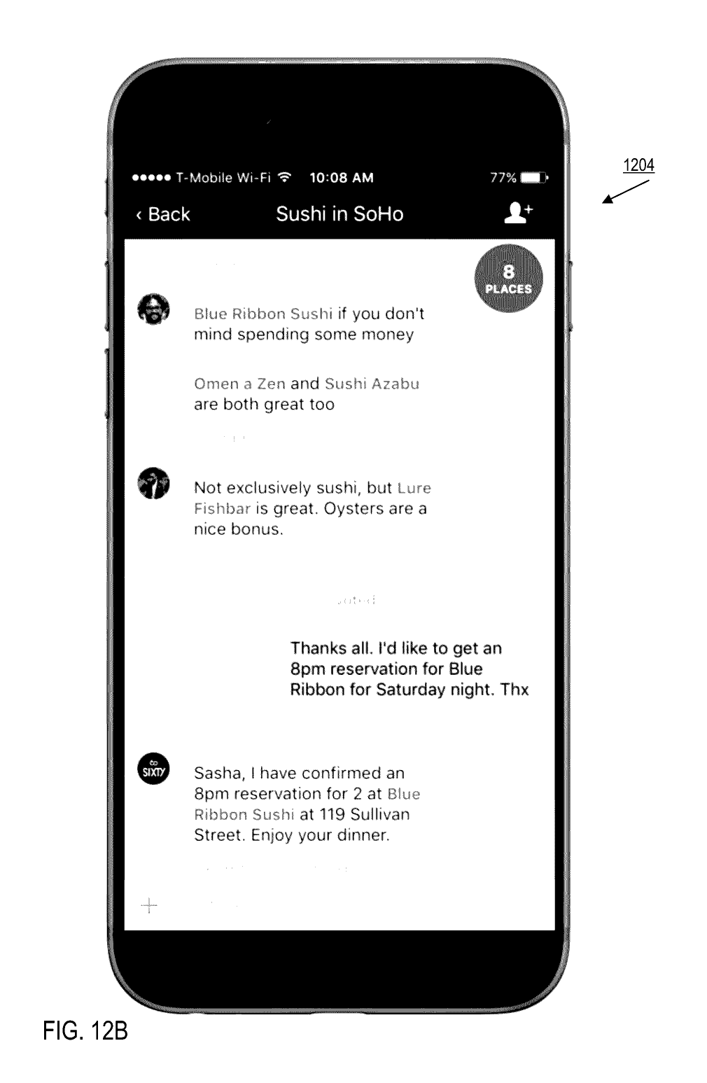

FIGS. 12A and 12B depict respective exemplary interfaces 1202 and 1204 (e.g., as generated/provided by dynamic messaging application 292 executing on device 102 and presented via a display, e.g., a touchscreen display) in which further communications/actions can be initiated/taken with respect to the various establishments referenced herein. For example, each of the depicted establishments can be, for example, a selectable hotlink that, when selected, can provide further information regarding the selected establishment (and that such an interface, which depicts information regarding a particular establishment, can further include links back to the conversations interface and/or the interface depicting the curated list). Thus, having identified/selected an appropriate establishment, the requesting user can further request a reservation, access, etc., whether by engaging the establishment directly and/or through one or more intermediaries (e.g., a concierge service, etc.).

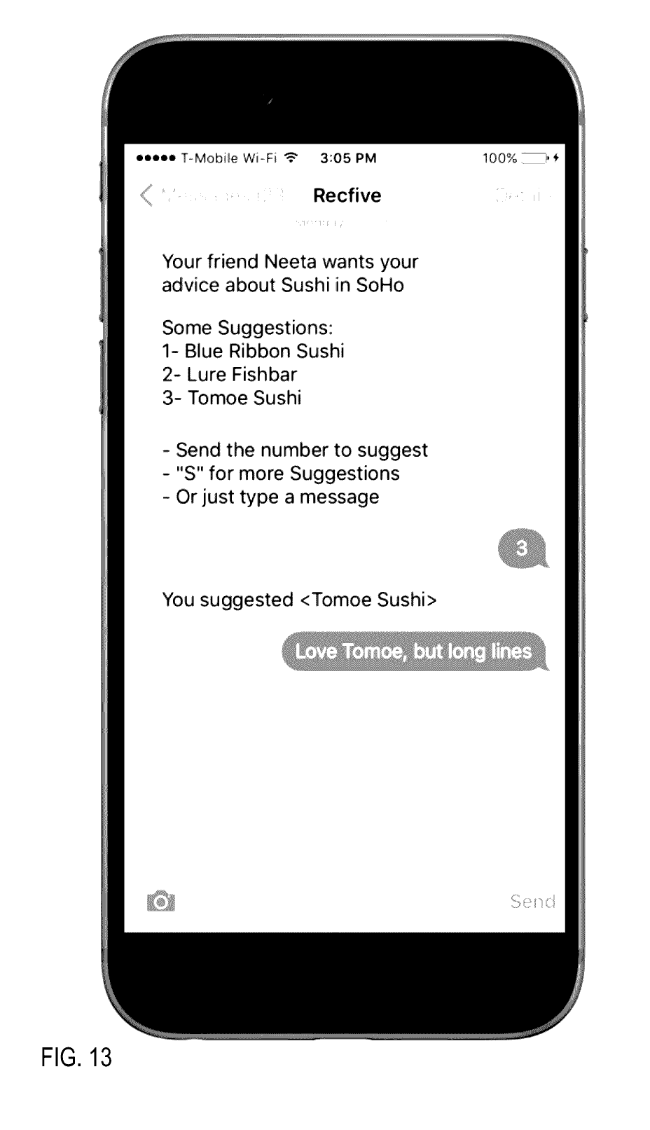

FIG. 13 depicts an exemplary interface in which the described technologies can be integrated within a third-party platform/service, such as a third-party messaging application (e.g., WhatsApp, iMessage, SMS, etc.). As shown in FIG. 13, dynamic messaging engine 130 and/or server 120 can interface with such a third-party platform/service, e.g., in order to provide various functionality described herein (e.g., the curated content/lists, requests for feedback, etc.) via such a platform/service. As shown in FIG. 13, the various content requests, curated list(s), responses/feedback described and/or referenced herein can be provided via a third-party messaging service (and may be further formatted accordingly in order to comply with various restrictions, limitations, etc., of such services). In doing so, the described technologies can be implemented with respect to existing platforms, services, applications, etc., thereby enabling requesting users to, for example, solicit feedback from other users/contacts, including those which may not have dynamic messaging application 292 installed on their device.

It should also be noted that while the technologies described herein are illustrated primarily with respect to messaging/content recommendations, the described technologies can also be implemented in any number of additional or alternative settings or contexts and towards any number of additional objectives. Additionally, it should be understood that while many of the foregoing examples and illustrations have been provided with respect to restaurants, the described technologies are not so limited. Accordingly, it should be appreciated that the described technologies can be applied to practically any other context, industry, setting, etc., with respect to which it may be advantageous for users to solicit feedback from others.

FIG. 14 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a computing device integrated within and/or in communication with a vehicle, a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1400 includes a processing system (processor) 1402, a main memory 1404 (e.g., read-only memory (ROM), flash memory, dynamic random access memory (DRAM) such as synchronous DRAM (SDRAM)), a static memory 1406 (e.g., flash memory, static random access memory (SRAM)), and a data storage device 1416, which communicate with each other via a bus 1408.

Processor 1402 represents one or more processing devices such as a microprocessor, central processing unit, or the like. More particularly, the processor 1402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1402 may also be one or more processing devices such as an application specific integrated circuit (ASIC), a field programmable gate array (FPGA), a digital signal processor (DSP), network processor, or the like. The processor 1402 is configured to execute instructions 1426 for performing the operations discussed herein.

The computer system 1400 may further include a network interface device 1422. The computer system 1400 also may include a video display unit 1410 (e.g., a touchscreen, liquid crystal display (LCD), or a cathode ray tube (CRT)), an alphanumeric input device 1412 (e.g., a keyboard), a cursor control device 1414 (e.g., a mouse), and a signal generation device 1420 (e.g., a speaker).

The data storage device 1416 may include a computer-readable medium 1424 on which is stored one or more sets of instructions 1426 (e.g., instructions executed by server machine 120, etc.) embodying any one or more of the methodologies or functions described herein. Instructions 1426 may also reside, completely or at least partially, within the main memory 1404 and/or within the processor 1402 during execution thereof by the computer system 1400, the main memory 1404 and the processor 1402 also constituting computer-readable media. Instructions 1426 may further be transmitted or received over a network via the network interface device 1422.

While the computer-readable storage medium 1424 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “processing,” “providing,” “identifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. A computer program to activate or configure a computing device accordingly may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to practically any type of data. The scope of the disclosure should, therefore, be determined with reference to the appended claims, along with the full scope of equivalents to which such claims are entitled.

What is claimed is:

1. A method comprising:
receiving, from a first device associated with a first user, a selection of one or more contacts;
receiving one or more request parameters from the first device;
identifying, by a processing device and based on the selection of the one or more contacts and the one or more request parameters, one or more content items that are (a) associated with at least one of the one or more contacts and (b) associated with at least one of the one or more request parameters; and
providing a first list of the one or more content items to the first device and to one or more devices that correspond to the one or more contacts.

2. The method of claim 1, further comprising:
receiving one or more inputs from the first device with respect to the first list; and
in response to the one or more inputs received from the first device, adjusting a presentation of the first list at the one or more devices that correspond to the one or more contacts.

3. The method of claim 2, wherein adjusting a presentation of the first list comprises removing at least one of the one or more content items from the list.

4. The method of claim 2, wherein adjusting a presentation of the first list comprises adding another content item to the list.

5. The method of claim 2, wherein adjusting a presentation of the first list comprises adjusting a relative position of at least one of the one or more content items within the list.

6. The method of claim 1, further comprising:
receiving one or more inputs with respect to the first list from at least one of the one or more devices that correspond to the one or more contacts; and
in response to the one or more inputs received from the at least one of the one or more devices that correspond to the one or more contacts, adjusting a presentation of the first list at the first device.

7. The method of claim 6, further comprising:
receiving a content request from a second device associated with a second user, the content request comprising at least one of the one or more request parameters;
identifying, based on the one of the one or more request parameters, the one or more inputs received with respect to the first list; and
providing, to the second device and based on the one or more inputs received with respect to the first list, a second list, the second list comprising at least one of the one or more content items.

8. The method of claim 7, wherein providing a second list comprises providing, to the second device, a second list, the second list comprising at least one of the one or more content items and an indication of the one or more contacts that provided the one or more inputs received with respect to the at least one of the one or more content items.

9. The method of claim 1, wherein the one or more request parameters comprise one or more geographical locations.

10. The method of claim 1, wherein receiving one or more request parameters comprises:
receiving a message from the first device; and
processing the message to identify the one or more request parameters.

11. The method of claim 1, further comprising:
identifying one or more additional contacts that are relevant to the one or more request parameters; and
providing, at the first device, an option to transmit the first list of the one or more content items to the one or more additional contacts.

12. A system comprising:
a memory; and
a processing device, operatively coupled to the memory, to:
receive, from a first device associated with a first user, a selection of one or more contacts;
receive one or more request parameters from the first device;
identify, based on the selection of the one or more contacts and the one or more request parameters, one or more content items that are (a) associated with at least one of the one or more contacts and (b) associated with at least one of the one or more request parameters; and
provide a first list of the one or more content items to the first device and to one or more devices that correspond to the one or more contacts.

13. The system of claim 12, wherein the processing device is further to:
receive one or more inputs from the first device with respect to the first list; and
in response to the one or more inputs received from the first device, adjust a presentation of the first list at the one or more devices that correspond to the one or more contacts.

14. The system of claim 12, wherein the processing device is further to:
receive one or more inputs with respect to the first list from at least one of the one or more devices that correspond to the one or more contacts; and
in response to the one or more inputs received from the at least one of the one or more devices that correspond to the one or more contacts, adjust a presentation of the first list at the first device.

15. The system of claim 14, wherein the processing device is further to:
receive a content request from a second device associated with a second user, the content request comprising at least one of the one or more request parameters;
identify, based on the one of the one or more request parameters, the one or more inputs received with respect to the first list; and
provide, to the second device and based on the one or more inputs received with respect to the first list, a second list, the second list comprising at least one of the one or more content items.

16. The system of claim 15, wherein to provide a second list the processing device is further to provide, to the second device, a second list, the second list comprising at least one of the one or more content items and an indication of the one or more contacts that provided the one or more inputs received with respect to the at least one of the one or more content items.

17. The system of claim 12, wherein the one or more request parameters comprise one or more geographical locations.

18. The system of claim 12, wherein to receive one or more request parameters the processing device is further to:
receive a message from the first device; and
process the message to identify the one or more request parameters.

19. The system of claim 12, wherein the processing device is further to:
identify one or more additional contacts that are relevant to the one or more request parameters; and
provide, at the first device, an option to transmit the first list of the one or more content items to the one or more additional contacts.

20. A non-transitory computer readable medium having instructions stored thereon that, when executed by a processing device, cause the processing device to:
receive, from a first device associated with a first user, a selection of one or more contacts;
receive one or more request parameters from the first device;
identify, based on the selection of the one or more contacts and the one or more request parameters, one or more content items that are (a) associated with at least one of the one or more contacts and (b) associated with at least one of the one or more request parameters;
provide a first list of the one or more content items to the first device and to one or more devices that correspond to the one or more contacts;
receive one or more inputs with respect to the first list from at least one of the one or more devices that correspond to the one or more contacts;
in response to the one or more inputs received from the at least one of the one or more devices that correspond to the one or more contacts, adjust a presentation of the first list at the first device;
receive a content request from a second device associated with a second user, the content request comprising at least one of the one or more request parameters;
identify, based on the one of the one or more request parameters, the one or more inputs received with respect to the first list; and
provide, to the second device and based on the one or more inputs received with respect to the first list, a second list, the second list comprising at least one of the one or more content items and an indication of the one or more contacts that provided the one or more inputs received with respect to the at least one of the one or more content items.
